(19) United States
(12) Patent Application Publication
(10) Pub. No.: US 2026/0039105 A1
(43) Pub. Date: Feb. 5, 2026

(54) SOLID-STATE CIRCUIT BREAKER CONFIGURED WITH AT LEAST ONE FAIL-OPEN MECHANISM AND PROCESS OF IMPLEMENTING THE SAME

(71) Applicant: WOLFSPEED, INC., Durham, NC (US)

(72) Inventors: Ajit KANALE, Morrisville, NC (US); Prasanna Obala BHUVANESH, Leander, TX (US); Rahul POTERA, Apex, NC (US)

(21) Appl. No.: 18/791,725

(22) Filed: Aug. 1, 2024

(51) Int. Cl. H02H 5/04; H01H 37/00; H01H 37/52; H01H 37/70; H02H 3/02; H02H 3/05; H02H 3/06

(52) U.S. Cl. CPC H02H 5/048; H01H 37/002; H01H 37/521; H01H 37/70; H02H 3/025; H02H 3/05; H01H 2037/705; H02H 3/066

(57) ABSTRACT

A solid state circuit breaker includes at least one power device and a control circuit configured to detect a fault and further configured to control operation of the at least one power device to open and electrically disconnect a power source from a load. Further, the solid state circuit breaker includes at least one fail-open device.

### FIELD OF THE DISCLOSURE

The disclosure is directed to a solid-state circuit breaker configured with at least one fail-open mechanism. The disclosure is further directed to a process of implementing a solid-state circuit breaker configured with at least one fail-open mechanism.

### BACKGROUND OF THE DISCLOSURE

A circuit breaker is typically an electrical safety device designed to protect components in a system, such as an electrical circuit, devices, equipment, and/or the like from damage caused by overcurrent during a fault. A typical circuit breaker interrupts current flow to protect the components. Further, a typical circuit breaker will use an electro-mechanical relay to create a physical air-gap and interrupt the current flow in the system.

Solid-state circuit breakers, also known as digital circuit breakers, implement electrical circuit breaker technology that may implement a power semiconductor device. However, while solid state circuit breakers present fewer moving parts with higher reliability against mechanical failures compared to conventional circuit breakers, it is not possible to ensure that the solid state circuit breaker and/or the power semiconductor device fails as an open circuit in case of faults in the system.

Accordingly, a solid-state circuit breaker configured to ensure an open circuit in case of faults is needed.

### SUMMARY OF THE DISCLOSURE

The foregoing needs are met, to a great extent, by the disclosure, wherein in one aspect a solid-state circuit breaker is configured with at least one fail-open mechanism is provided. Additionally or alternatively, the foregoing needs are met, to a great extent, by the disclosure, wherein in one aspect a process of implementing a solid-state circuit breaker configured with at least one fail-open mechanism is provided.

In one aspect, a solid state circuit breaker includes at least one power device. The solid state circuit breaker in addition includes a control circuit configured to detect a fault and further configured to control operation of the at least one power device to open and electrically disconnect a power source from a load. The solid state circuit breaker moreover includes at least one fail-open device.

In one aspect, a solid state circuit breaker includes at least one power device. The solid state circuit breaker in addition includes a control circuit configured to detect a fault and further configured to control operation of the at least one power device to open and electrically disconnect a power source from a load. The solid state circuit breaker moreover includes at least one fail-open device. The solid state circuit breaker also includes where the at least one fail-open device comprises at least one fuse and/or a first connection structure and a second connection structure.

In one aspect, a process includes providing at least one power device. The process in addition includes detecting a fault with a control circuit and controlling with the control circuit an operation of the at least one power device to open and electrically disconnect a power source from a load. The process moreover includes providing at least one fail-open device.

In one aspect, a process includes providing at least one power device. The process in addition includes detecting a fault with a control circuit and controlling with the control circuit an operation of the at least one power device to open and electrically disconnect a power source from a load. The process moreover includes providing at least one fail-open device. The process also includes where the at least one fail-open device comprises at least one fuse and/or a first connection structure and a second connection structure.

In one aspect, a fail-open device includes a first connection structure. The fail-open device in addition includes a second connection structure. The fail-open device moreover includes where the first connection structure is configured to be electrically disconnected from the second connection structure above a certain current flow.

In one aspect, a process includes providing a first connection structure. The process in addition includes providing a second connection structure. The process moreover includes configuring at least the first connection structure to be electrically disconnected from the second connection structure above a certain current flow.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 illustrates a schematic of a system implementing a solid-state circuit breaker according to aspects of the disclosure.

FIG. 2 illustrates a schematic of a system implementing another solid-state circuit breaker according to aspects of the disclosure.

FIG. 3 illustrates a schematic of a system implementing another solid-state circuit breaker according to aspects of the disclosure.

FIG. 4 illustrates a schematic of a system implementing another solid-state circuit breaker according to aspects of the disclosure.

FIG. 5 illustrates a side view with further details of the solid state circuit breaker together with an exemplary implementation of the at least one fail-open mechanism according to aspects of the disclosure during nominal operations.

FIG. 6 illustrates a side view with further details of the solid state circuit breaker together with the exemplary implementation of the at least one fail-open mechanism of FIG. 5 during current surge and/or overheating.

FIG. 7 illustrates a side view with further exemplary details of the solid state circuit breaker together with an exemplary implementation of the at least one fail-open mechanism according to FIG. 5 during nominal operations.

FIG. 8 illustrates a side view with further exemplary details of the solid state circuit breaker together with an exemplary implementation of the at least one fail-open mechanism according to FIG. 5 during nominal operations.

FIG. 9 illustrates a side view with further details of the solid state circuit breaker together with an exemplary implementation of the at least one fail-open mechanism according to aspects of the disclosure during nominal operations.

FIG. 10 illustrates a side view with further details of the solid state circuit breaker together with the exemplary implementation of the at least one fail-open mechanism of FIG. 9 during current surge and/or overheating.

FIG. 11 illustrates a side view with further details of the solid state circuit breaker together with an exemplary implementation of the at least one fail-open mechanism according to aspects of the disclosure during nominal operations.

FIG. 12 illustrates a side view with further details of the solid state circuit breaker together with the exemplary implementation of the at least one fail-open mechanism of FIG. 11 during current surge and/or overheating.

FIG. 13 illustrates a perspective view with further details of the solid state circuit breaker together with an exemplary implementation of the at least one fail-open mechanism according to aspects of the disclosure.

FIG. 14 illustrates a perspective view with further details of the solid state circuit breaker together with an exemplary implementation of the at least one fail-open mechanism according to aspects of the disclosure.

FIG. 15 illustrates schematics of exemplary implementations of the at least one power device and the at least one second power device according to aspects of the disclosure.

FIG. 16 illustrates an exemplary schematic of a control circuit according to aspects of the disclosure.

### DETAILED DESCRIPTION

The disclosure will now be described with reference to the drawing figures, in which like reference numerals refer to like parts throughout. Aspects of the disclosure advantageously provide a solid-state circuit breaker is configured with at least one fail-open mechanism and a process of implementing a solid-state circuit breaker configured with at least one fail-open mechanism.

Conventional Circuit breakers use an electro-mechanical relay to create a physical air-gap and interrupt the current flow in a system. Solid state circuit breakers (SSCBs) may implement a semiconductor switch, with power terminals connecting a high-power source such as a power grid, a battery, a generator, and/or the like to a power electronic system. The SSCB may also have one or more control terminals to govern the power semiconductor switch turn-on and turn-off operation. The SSCB may be connected with a voltage clamping circuit in parallel to provide ruggedness against overvoltage events such as inductor kick-backs. In case of unidirectional SSCB applications, a standalone single or composite transistor may be used to interrupt currents. In case of bidirectional SSCB applications, back-to-back connected single or composite transistors may be used to interrupt currents.

In all the aforementioned configurations, a single transistor may be a Si (silicon) power MOSFET, a Si power JFET, a Si Superjunction MOSFET, Si IGBT, a SiC (silicon carbide) power MOSFET, a SIC JFET, a SiC IGBT, and/or the like. In aspects, the single transistor may be implemented as a single power transistor that may be a Si (silicon) power MOSFET, a Si power JFET, a Si Superjunction MOSFET, Si IGBT, a SiC (silicon carbide) power MOSFET, a SiC JFET, a SIC IGBT, and/or the like. Additionally, bidirectional SSCBs may be realized using common-source or common-drain topologies for single or composite switches.

While a solid state circuit breaker presents fewer moving parts with higher reliability against mechanical failures compared to conventional breakers, it is not possible to ensure that a power semiconductor device fails as an open circuit in case of faults. In commercial systems such as the power grid, this unreliability may require additional safety checks in place elsewhere in a power network to ensure a break in the current flow path. In this regard, the additional safety check may be implemented in the form of a physical air gap mechanism as disclosed herein. Moreover, the disclosure may implement the additional safety check within the solid state circuit breaker that may result in more reliable detection, faster action, and/or the like.

In aspects of the disclosure, a physical fail-open mechanism inside a power module may be implemented to ensure a physical air-gap in case of extreme current surges resulting in device failures.

In aspects of the disclosure, a bimetallic connection may be implemented from a semiconductor surface, such as a high-current terminal like the source or the drain, to a package frame. The advantage of this feature is that when selected properly, and provided the space, self-heating in the bimetallic strip causes it to deform and create a disconnect between the power semiconductor and the rest of the circuit. The physical air-gap thus created ensures that the breaker fails open in case of a high-current fault. In aspects, a dual-metal composition of the bimetallic strip may enable it to open the circuit automatically in the event of extreme heating due to high current flow.

In aspects, the solid state circuit breaker may be implemented in a power module with two rows of paralleled devices. Each power device may have a bimetallic strip connecting its source pad to the high-current source terminal. The bimetallic strip may be implemented and/or configured to separate and ensure a physical air-gap therebetween. In one aspect, the bimetallic strip may have two different metal bars-one, formed with a Metal 1 connected to a source pad on the power semiconductor, and the other formed with a Metal 2 connected to a source connection, such as a source copper trace, in a module frame of the solid state circuit breaker 100. In this aspect, the Metal 1 may be designed to have a lower coefficient of thermal expansion (CTE) compared to the Metal 2. This may result in dissimilar expansion of the metal bars when heated due to current surges. Dissimilar expansion in the bimetallic strip ensures a physical air-gap. In other aspects, the bimetallic strip may be implemented and/or configured in other forms to separate and ensure a physical air-gap therebetween.

In aspects, during normal operations, the bimetallic strip halves remain connected. During current surge events, the Metal 1 and the Metal 2 may expand in opposite directions, thus ensuring a physical disconnect in the current flow path.

In aspects, the bimetallic strip may include two parts, each made of a single metal. One part connecting to a power terminal, and the other part connecting to the power semiconductor. The difference in the CTE of the two metals may cause them to bend away in opposite directions and create a physical air-gap.

In aspects, the bimetallic strip may include two parts, each made of a bonding metal formed with a Metal 1 and a contact metal formed with a Metals 2a and 2b). The bonding metal of one part is connected to the power terminal in the power module, and the bonding metal of the other part may be connected to the power semiconductor. The contact metal in both parts may remain physically connected during normal operations, but bend in opposite directions during current surge events, due to their dissimilar CTEs. This behavior may ensure a physical air-gap under fault conditions.

In aspects, the bimetallic strip may include two parts, each made of two metal bars joined together. One part may be connected to the power terminal in the power module while the other is connected to the power semiconductor. Further, the bimetallic strip may include inner metals, a bimetal 1a and a bimetal 2b that have a higher CTE compared to a bimetal 1b and a bimetal 2a. This may force the two parts to bend in opposite directions when heated during large current surge events. This ensures a physical air-gap.

In aspects, the solid state circuit breaker may include a bimetallic clip that may connect to a source contact on a semiconductor to a source pad on module substrate. In aspects, the Metal 1 may have a lower coefficient of thermal expansion (CTE) compared to Metal 2. This may ensure that both metals physically disconnect under extreme currents that cause overheating.

In aspects, a bimetallic clip may be made of two pieces jointed along its length. The metal connecting to the semiconductor or the copper/substrate may be the same. This metal may be connected to metal 2a (higher CTE) on the copper/substrate side and metal 2b (low CTE) on the semiconductor side. Different CTEs may ensure dissimilar expansion and disconnect.

In aspects, the solid state circuit breaker include encapsulation cooling that may be sufficient to ensure connection during normal expected range of currents. In aspects, the encapsulation may allow for clip movement during extreme surge currents so that source disconnect happens due to unequal thermal expansion of clip halves.

In aspects, the solid state circuit breaker may include a Bimetallic strip 1 that may connect to the semiconductor. In aspects, the solid state circuit breaker may include a Bimetallic strip 2 that connects to the copper/substrate.

In aspects, the Bimetallic strip 1 may have a CTE such that: CTE 1a<CTE 1b. This may ensure that the Bimetallic strip 1 bends downwards on heating. In aspects, the Bimetallic strip 2 may have a CTE such that: CTE 2a<CTE 2b. This may ensure that the Bimetallic strip 2 bends upwards on heating.

In aspects, the solid state circuit breaker may include no bimetallic strips to create internal disconnect. In aspects, the solid state circuit breaker may include a separate source pad connected through paralleled micro fuses.

In aspects, the solid state circuit breaker may include a metal clip that may be configured to connect the source terminal to a housing. Alternatively, this may also be implemented as paralleled wire bonds.

In aspects, the solid state circuit breaker may include module encapsulation that may be placed to enclose all the objects between micro fuse placement arrays.

In aspects, the solid state circuit breaker may include micro fuses that may create a physical gap and can be replaced without interfering with the inner copper or the semiconductor assembly.

In aspects, the solid state circuit breaker may include power and signal terminals that may be wire-bonded, directly soldered, connected through metal-clips, and/or the like.

In aspects, the solid state circuit breaker may include copper pads for terminals that may be connected through ribbons, screws, pins, and/or the like using the extended areas outside the encapsulated region.

In aspects, the solid state circuit breaker may include a metal clip that may be created with a bimetallic strip to ensure a nuisance trip. In aspects, the bimetallic strip may reconnect after cooling down and reconnect, resuming normal operation.

In aspects, the solid state circuit breaker may include a separate source pad to allow placement of micro fuses.

In aspects, the solid state circuit breaker may include module encapsulation that may be placed as shown to enclose all the objects between the micro fuse placement arrays.

In aspects, the micro fuses may create a physical gap and can be replaced without interfering with the inner copper or the semiconductor assembly.

Aspects of the disclosure may be implemented in power packages containing single or multiple power semiconductors that may be used for unidirectional or bidirectional SSCB applications. The bimetallic strip behavior may ensure an air-gap, which is a safety mechanism in case the power semiconductor device fails short. Since it is not possible to ensure a fail-open directly at the power semiconductor level, the bimetallic strip may help ensure a fail-open. In aspects of the disclosure, a power package may refer to a discrete housing containing a single standalone transistor, a single cascode transistor, a module containing multiple transistors, a module containing multiple standalone transistors, a module containing multiple cascode transistors, and/or the like.

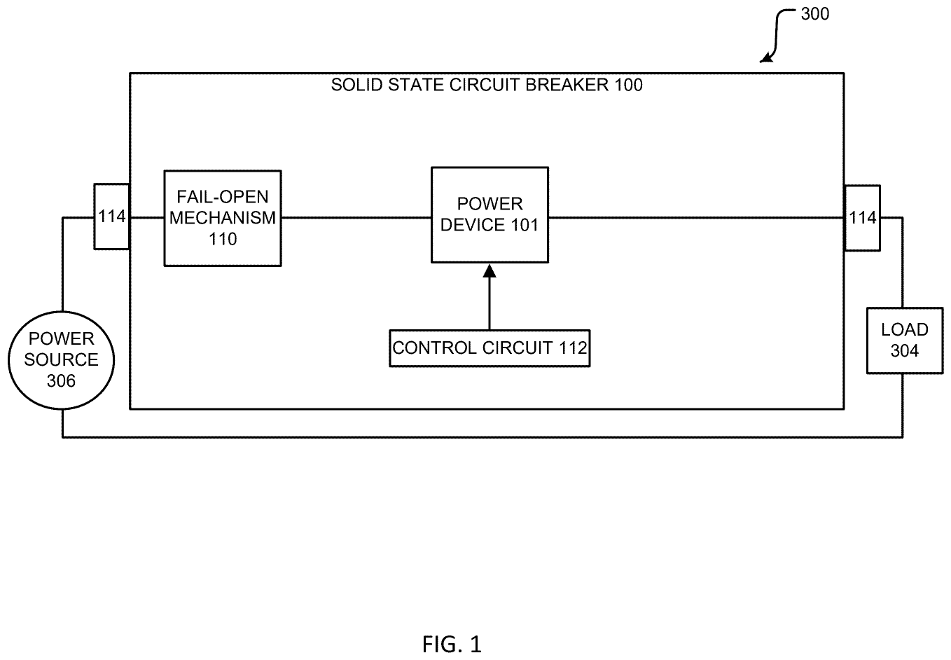

FIG. 1 illustrates a schematic of a system implementing a solid-state circuit breaker according to aspects of the disclosure.

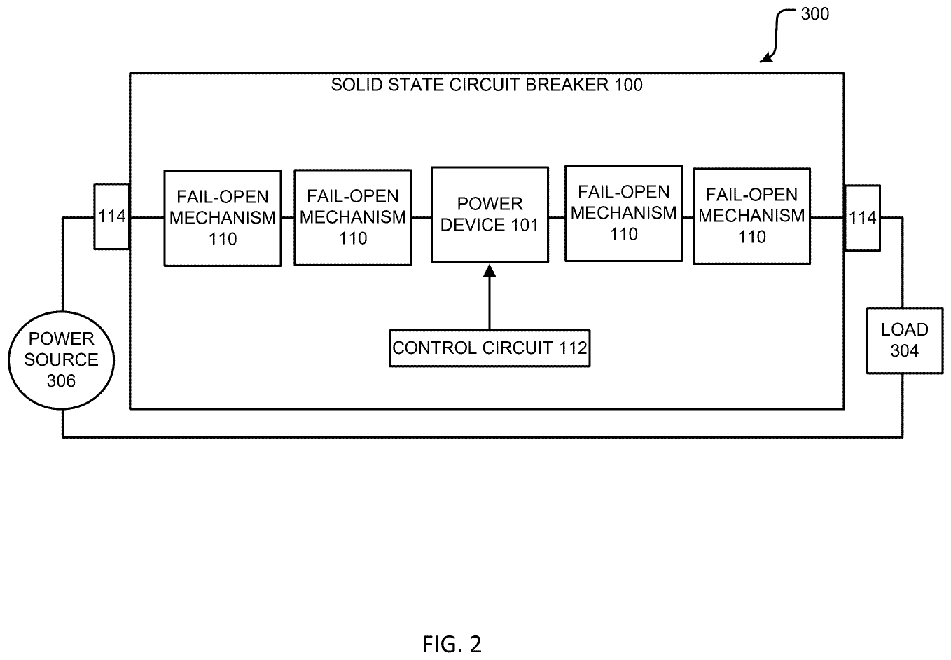

FIG. 2 illustrates a schematic of a system implementing another solid-state circuit breaker according to aspects of the disclosure.

In particular, FIG. 1 illustrates a system 300 implementing a solid state circuit breaker 100. In aspects, the solid state circuit breaker 100 may be configured as a unidirectional implementation or bidirectional implementation of the solid state circuit breaker 100. Further, the solid state circuit breaker 100 may include at least one power device 101, at least one fail-open mechanism 110, a control circuit 112, power terminals 114, and/or the like. In aspects, the at least one fail-open mechanism 110 may be configured as a fail-open device, a fail-open circuit, a fail-open configuration, a fail-open arrangement, and/or the like. In aspects, the at least one fail-open mechanism 110 may be configured to be operated separate from the solid state circuit breaker 100. In aspects, the at least one fail-open mechanism 110 may be implemented in any device that may benefit from a fail open mechanism.

In aspects, the system 300 may include a power source 306 and a load 304. In aspects, the power source 306 may be a DC power source and/or an AC power source. In aspects, the solid state circuit breaker 100 may be configured as a unidirectional implementation of the solid state circuit breaker 100; and the power source 306 may be a DC power source.

In aspects, during normal operation, the solid state circuit breaker 100 may electrically connect the power source 306 to the load 304 through the power terminals 114. Accordingly, the solid state circuit breaker 100 may provide power from the power source 306 to the load 304 during normal operation.

In aspects, during a fault the solid state circuit breaker 100 may interrupt current flow between the power source 306 and the load 304. In particular, the solid state circuit breaker 100 may electrically disconnect the power source 306 from the load 304.

More specifically, the solid state circuit breaker 100 may be configured to detect a fault and further configured to control operation of the at least one power device 101 to open and electrically disconnect the power source 306 from the load 304. In aspects, the solid state circuit breaker 100 may detect a fault and control operation of the at least one power device 101 with the control circuit 112. In aspects, the control circuit 112 may be configured to detect a fault and further configured to control operation of the at least one power device 101 to open and electrically disconnect the power source 306 from the load 304. Accordingly, the solid state circuit breaker 100 may limit overcurrent between the power source 306 and the load 304 and protect the power source 306 and the load 304 from damage.

However, should the solid state circuit breaker 100 not interrupt current flow between the power source 306 and the load 304 during a fault operation, the at least one fail-open mechanism 110 may provide a physical fail-open mechanism to ensure a physical air-gap in case of extreme current surges.

In aspects, the at least one fail-open mechanism 110 may be arranged between the at least one power device 101 and the power source 306 as illustrated in FIG. 1. In aspects, the at least one fail-open mechanism 110 may be arranged between the at least one power device 101 and the load 304 as illustrated in FIG. 2.

In aspects, the at least one fail-open mechanism 110 may be arranged between the at least one power device 101 and the power source 306; and another implementation of the at least one fail-open mechanism 110 may be arranged between the at least one power device 101 and the load 304 as illustrated in FIG. 2.

As further illustrated in FIG. 2, there may be multiple implementations of the at least one fail-open mechanism 110 arranged between the at least one power device 101 and the power source 306, there may be multiple implementations of the at least one fail-open mechanism 110 arranged between the at least one power device 101 and the load 304, and/or the like.

The at least one fail-open mechanism 110 may be implemented by a number of different configurations as described herein. In aspects, the solid state circuit breaker 100 may implement the different configurations of the at least one fail-open mechanism 110. In other aspects, the solid state circuit breaker 100 may implement a single configuration of the at least one fail-open mechanism 110. Further exemplary details of the at least one fail-open mechanism 110 are provided below.

In aspects of the disclosure, the solid state circuit breaker 100 may be implemented as a power package, a package, a power module, a module, and/or the like. In aspects, a power package may refer to a discrete housing containing the at least one power device 101; and the at least one power device 101 may be implemented as a single standalone transistor, a single cascode transistor, and/or the like. In aspects, the solid state circuit breaker 100 may be implemented with the at least one power device 101 as a module containing multiple transistors, a module containing multiple standalone transistors, a module containing multiple cascode transistors, and/or the like.

Aspects of the solid state circuit breaker 100 and/or the at least one fail-open mechanism 110 described in relation to FIGS. 1-2 may optionally be implemented in any other aspects of the solid state circuit breaker 100 and/or the at least one fail-open mechanism 110 described and/or illustrated herein. Moreover, aspects of the solid state circuit breaker 100 and/or the at least one fail-open mechanism 110 described and/or illustrated herein may optionally be implemented in the aspects of the solid state circuit breaker 100 and/or the at least one fail-open mechanism 110 illustrated in FIGS. 1-2 described therewith.

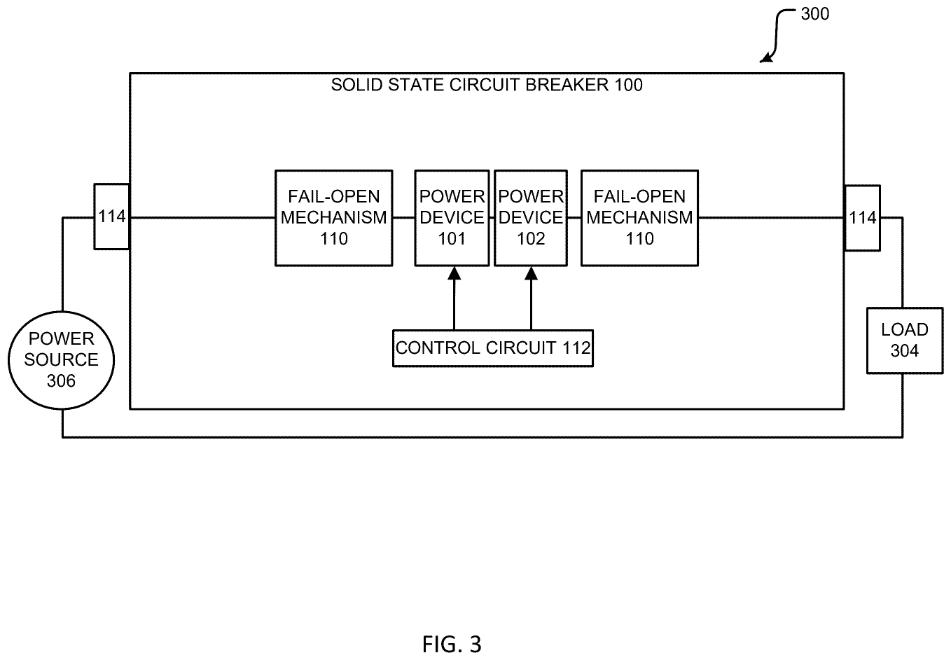

FIG. 3 illustrates a schematic of a system implementing another solid-state circuit breaker according to aspects of the disclosure.

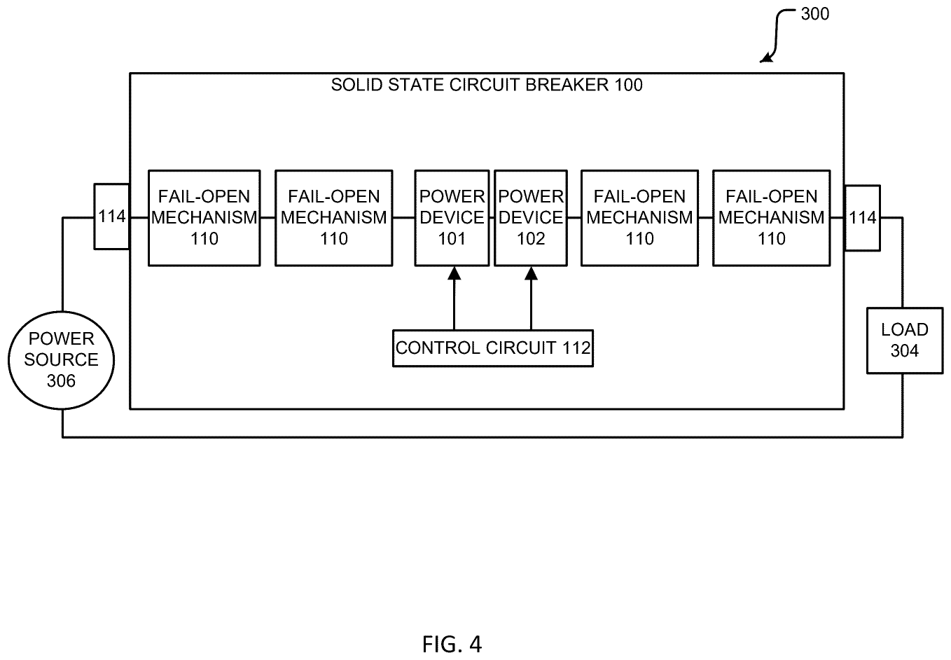

FIG. 4 illustrates a schematic of a system implementing another solid-state circuit breaker according to aspects of the disclosure.

With reference to FIG. 4, the solid state circuit breaker 100 may include the at least one power device 101, the at least one fail-open mechanism 110, the control circuit 112, and/or the like as previously described. Additionally, the solid state circuit breaker 100 may further include at least one second power device 102, and another implementation of the at least one fail-open mechanism 110. In aspects, the solid state circuit breaker 100 may be configured as a bi-directional implementation of the solid state circuit breaker 100; and the power source 306 may be an AC power source.

In aspects, the solid state circuit breaker 100 may be configured to detect a fault and further configured to control operation of the at least one power device 101 and/or the at least one second power device 102 to open and electrically disconnect the power source 306 from the load 304. In aspects, the solid state circuit breaker 100 may detect a fault and control operation of the at least one power device 101 and/or the at least one second power device 102 with the control circuit 112. In aspects, the control circuit 112 may be configured to detect a fault and further configured to control operation of the at least one power device 101 and/or the at least one second power device 102 to open and electrically disconnect the power source 306 from the load 304.

In aspects, the at least one fail-open mechanism 110 may be arranged between the at least one power device 101 and the power source 306. In aspects, another implementation of the at least one fail-open mechanism 110 may be arranged between the at least one second power device 102 and the load 304. As further illustrated in FIG. 4, there may be multiple implementations of the at least one fail-open mechanism 110 arranged between the at least one power device 101 and the power source 306, there may be multiple implementations of the at least one fail-open mechanism 110 arranged between the at least one second power device 102 and the load 304, and/or the like.

The at least one fail-open mechanism 110 may be implemented by a number of different configurations as described herein. In aspects, the solid state circuit breaker 100 may implement the different configurations of the at least one fail-open mechanism 110. In other aspects, the solid state circuit breaker 100 may implement a single configuration of the at least one fail-open mechanism 110. Further exemplary details of the at least one fail-open mechanism 110 are provided below.

In aspects of the disclosure, the solid state circuit breaker 100 may be implemented as a power package, a package, a power module, a module, and/or the like. In aspects, a power package may refer to a discrete housing containing the at least one power device 101 and/or the at least one second power device 102; and the at least one power device 101 and/or the at least one second power device 102 may be implemented as a single standalone transistor, a single cascode transistor, and/or the like. In aspects, the solid state circuit breaker 100 may be implemented with the at least one power device 101 and/or the at least one second power device 102 as a module containing multiple transistors, a module containing multiple standalone transistors, a module containing multiple cascode transistors, and/or the like.

Aspects of the solid state circuit breaker 100 and/or the at least one fail-open mechanism 110 described in relation to FIGS. 3-4 may optionally be implemented in any other aspects of the solid state circuit breaker 100 and/or the at least one fail-open mechanism 110 described and/or illustrated herein. Moreover, aspects of the solid state circuit breaker 100 and/or the at least one fail-open mechanism 110 described and/or illustrated herein may optionally be implemented in the aspects of the solid state circuit breaker 100 and/or the at least one fail-open mechanism 110 illustrated in FIGS. 3-4 and described therewith.

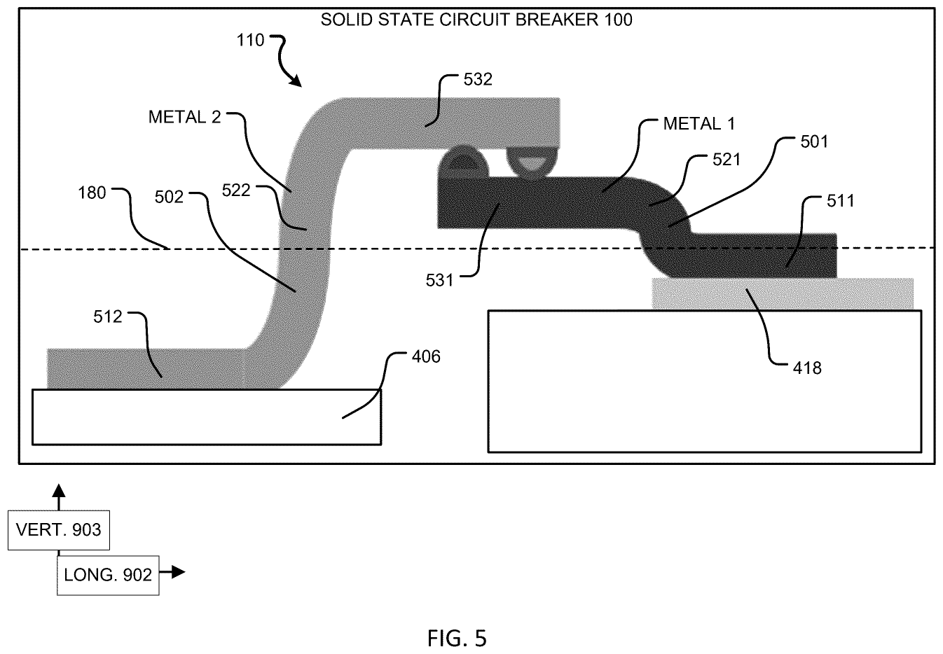

FIG. 5 illustrates a side view with further details of the solid state circuit breaker together with an exemplary implementation of the at least one fail-open mechanism according to aspects of the disclosure during nominal operations.

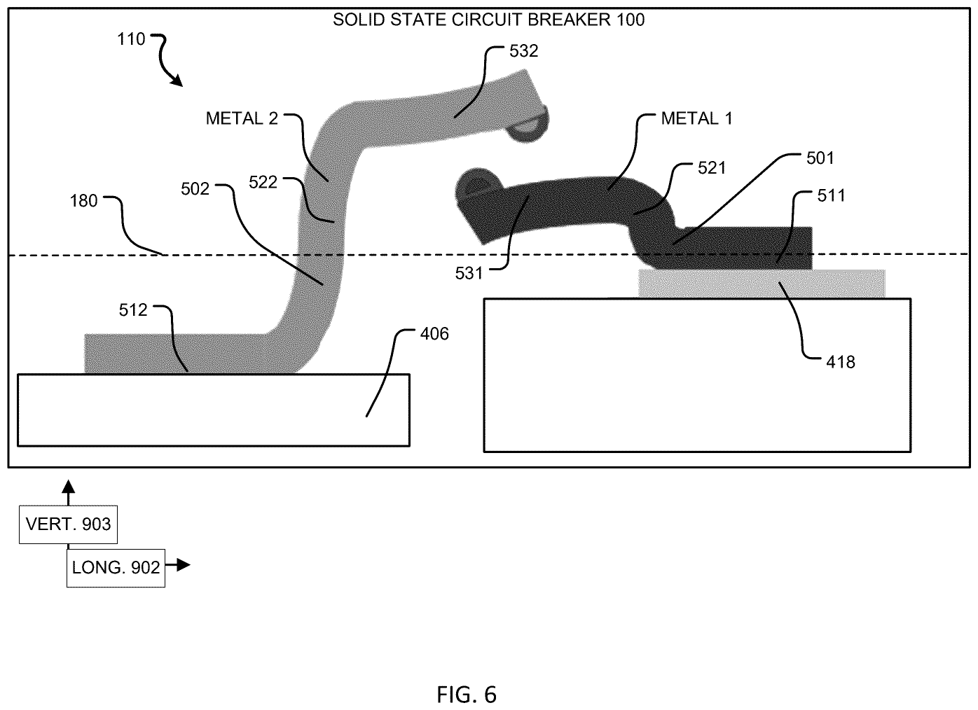

FIG. 6 illustrates a side view with further details of the solid state circuit breaker together with the exemplary implementation of the at least one fail-open mechanism of FIG. 5 during current surge and/or overheating.

In particular, FIG. 5 illustrates further details of the solid state circuit breaker 100 together with an exemplary implementation of the at least one fail-open mechanism 110 according to aspects of the disclosure during nominal operations. In aspects, the solid state circuit breaker 100 may include the at least one fail-open mechanism 110 as previously described. In aspects, the at least one fail-open mechanism 110 may be configured as a bimetallic clip, a bimetallic structure, a bimetallic connection, and/or the like.

In aspects, the at least one fail-open mechanism 110 may be configured as a two-piece clip, a two-piece structure, a two-piece connection, and/or the like. In aspects, the at least one fail-open mechanism 110 may be configured as a multiple piece clip, a multiple piece structure, a multiple piece connection, and/or the like.

In aspects, the at least one fail-open mechanism 110 may be configured as a two material clip, a two material structure, a two material connection, and/or the like. In aspects, the at least one fail-open mechanism 110 may be configured as a multiple material clip, a multiple material structure, a multiple material connection, and/or the like.

In aspects, the solid state circuit breaker 100 may include a first pad 418, a second pad 406, and/or the like. In aspects, the first pad 418 may be electrically connected to the power source 306, the at least one power device 101, the at least one second power device 102, or the load 304. In aspects, the second pad 406 may be electrically connected to the power source 306, the at least one power device 101, the at least one second power device 102, or the load 304.

In aspects, the at least one fail-open mechanism 110 may connect to the second pad 406 and the at least one fail-open mechanism 110 may connect to the first pad 418. In aspects, the at least one fail-open mechanism 110 may include a first connection structure 501 and a second connection structure 502.

In aspects, the first connection structure 501 may connect to the first pad 418. The connection between the first connection structure 501 and the first pad 418 may be a solder connection, an adhesive connection, and/or the like.

In aspects, the second connection structure 502 may connect to the second pad 406. The connection between the second connection structure 502 and the second pad 406 may be a solder connection, an adhesive connection, and/or the like.

Further, the first connection structure 501 may be configured to be electrically connected to the second connection structure 502. In aspects, the first connection structure 501 may be configured to be electrically connected to the second connection structure 502 during nominal operations of the solid state circuit breaker 100, normal operations of the solid state circuit breaker 100, operations at or below a rated current of the solid state circuit breaker 100, operations without current surge through the solid state circuit breaker 100, operations without overheating of the solid state circuit breaker 100, and/or the like.

In this regard, the connection between the first connection structure 501 and the second connection structure 502 may be implemented by a mechanical interaction and/or mechanical arrangement between the first connection structure 501 and the second connection structure 502.

Further, the first connection structure 501 may be configured to be electrically disconnected from the second connection structure 502. In aspects, the first connection structure 501 may be configured to be electrically disconnected from the second connection structure 502 during non-nominal operations of the solid state circuit breaker 100, non-normal operations of the solid state circuit breaker 100, operations above a rated current of the solid state circuit breaker 100, overcurrent operations of the solid state circuit breaker 100, operations with current surge through the solid state circuit breaker 100, operations with overheating of the solid state circuit breaker 100, and/or the like.

In aspects, the first connection structure 501 and/or the second connection structure 502 may be configured such that the first connection structure 501 may be electrically disconnected from the second connection structure 502 and stay disconnected. In aspects, the first connection structure 501 and/or the second connection structure 502 may be configured with materials, constructions, arrangements, configurations, and/or the like such that the first connection structure 501 may be electrically disconnected from the second connection structure 502 and stay disconnected.

In aspects, the first connection structure 501 and/or the second connection structure 502 may be configured such that the first connection structure 501 may be electrically disconnected from the second connection structure 502 and subsequently reconnect. In aspects, the first connection structure 501 and/or the second connection structure 502 may be configured with materials, constructions, arrangements, configurations, and/or the like such that the first connection structure 501 may be electrically disconnected from the second connection structure 502 and subsequently reconnect.

In particular aspects, materials forming the first connection structure 501 and the second connection structure 502 may have different attributes. The different attributes of the first connection structure 501 and the second connection structure 502 may include at least one different material, materials with different coefficients of thermal expansion (CTE), different structures, different structural configurations, different arrangements, and/or the like such that the first connection structure 501 and the second connection structure 502 change shape and form an airgap therebetween.

In aspects, the first connection structure 501 and the second connection structure 502 may be configured with the different attributes to change shape and form an airgap therebetween during non-nominal operations of the solid state circuit breaker 100, non-normal operations of the solid state circuit breaker 100, operations above a rated current of the solid state circuit breaker 100, overcurrent operations of the solid state circuit breaker 100, operations with current surge through the solid state circuit breaker 100, operations with overheating of the solid state circuit breaker 100, and/or the like.

In aspects, the second connection structure 502 may be arranged between the power terminals 114 and the at least one power device 101, between the power terminals 114 and the at least one second power device 102, and/or the like.

In aspects, the first connection structure 501 may be arranged between the second connection structure 502 and the at least one power device 101, between the second connection structure 502 and the at least one second power device 102, and/or the like.

In other aspects not illustrated, the second connection structure 502 may be arranged between the first connection structure 501 and the at least one power device 101, between the first connection structure 501 and the at least one second power device 102, and/or the like. In other aspects not illustrated, the first connection structure 501 may be arranged between the power terminals 114 and the at least one power device 101, between the power terminals 114 and the at least one second power device 102, and/or the like.

In aspects, the second connection structure 502 may be arranged at least in part above the first connection structure 501, the second connection structure 502 may be arranged at least in part below the first connection structure 501, and/or the like.

In aspects, the first connection structure 501 may be formed at least in part by a Metal 1. The Metal 1 may be configured to have a coefficient of thermal expansion (CTE). In aspects, the Metal 1 may include one or more metals, metal alloys, shape memory materials, shape memory alloys, memory metals, memory alloys, smart metals, smart alloys, muscle wires, and/or the like.

In aspects, the second connection structure 502 may be formed at least in part by a Metal 2. The Metal 2 may be configured to have a coefficient of thermal expansion (CTE). In aspects, the Metal 2 may include one or more metals, metal alloys, shape memory materials, shape memory alloys, memory metals, memory alloys, smart metals, smart alloys, muscle wires, and/or the like. In aspects, the Metal 1 is a different material from the Metal 2.

In aspects, the Metal 1 may have a different coefficient of thermal expansion (CTE) compared to a coefficient of thermal expansion (CTE) of the Metal 2. In aspects, the coefficient of thermal expansion (CTE) of the first connection structure 501 may be different than a coefficient of thermal expansion (CTE) of the second connection structure 502.

In aspects, the Metal 1 may have a lower coefficient of thermal expansion (CTE) compared to a coefficient of thermal expansion (CTE) of the Metal 2. In aspects, the coefficient of thermal expansion (CTE) of the first connection structure 501 may be lower than a coefficient of thermal expansion (CTE) of the second connection structure 502.

In aspects, the first connection structure 501 may include an attachment portion 511, a body portion 521, and a connection portion 531. In aspects, the attachment portion 511 may attach the first connection structure 501 to the first pad 418. Further, the attachment portion 511 may extend to the body portion 521; and the body portion 521 may extend to the connection portion 531. In aspects, the attachment portion 511 may be connected to the body portion 521; and the body portion 521 may be connected to the connection portion 531. In aspects, the attachment portion 511, the body portion 521, and the connection portion 531 are a single continuous structure.

Additionally, the attachment portion 511 may extend generally along a longitudinal axis 902; and the connection portion 531 may extend generally along the longitudinal axis 902. Further, at least a portion of the body portion 521 may extend generally along a vertical axis 903.

In aspects, the second connection structure 502 may include an attachment portion 512, a body portion 522, and a connection portion 532. In aspects, the attachment portion 512 may attach the second connection structure 502 to the second pad 406. Further, the attachment portion 512 may extend to the body portion 522; and the body portion 522 may extend to the connection portion 532. In aspects, the attachment portion 512 may be connected to the body portion 522; and the body portion 522 may be connected to the connection portion 532. In aspects, the attachment portion 512, the body portion 522, and the connection portion 532 are single continuous structure.

Additionally, the attachment portion 512 may extend generally along the longitudinal axis 902; and the connection portion 532 may extend generally along the longitudinal axis 902. Further, at least a portion of the body portion 522 may extend generally along the vertical axis 903.

In aspects, the connection portion 532 of the second connection structure 502 may contact, electrically contact, connect, electrically connect, and/or the like to the connection portion 531 of the first connection structure 501. In aspects, the connection portion 531 may be configured to be electrically connected to the connection portion 532 during nominal operations of the solid state circuit breaker 100, normal operations of the solid state circuit breaker 100, operations at or below a rated current of the solid state circuit breaker 100, operations without current surge through the solid state circuit breaker 100, operations without overheating of the solid state circuit breaker 100, and/or the like. In this regard, the connection between the connection portion 531 and the connection portion 532 may be implemented by a mechanical interaction and/or mechanical arrangement between the connection portion 531 and the connection portion 532.

Further, the connection portion 531 may be configured to be electrically disconnected from the connection portion 532. In aspects, the connection portion 531 may be configured to be electrically disconnected from the connection portion 532 during non-nominal operations of the solid state circuit breaker 100, non-normal operations of the solid state circuit breaker 100, operations above a rated current of the solid state circuit breaker 100, operations with current surge through the solid state circuit breaker 100, operations with overheating of the solid state circuit breaker 100, and/or the like.

In aspects, the connection portion 531 and/or the connection portion 532 may be configured such that the connection portion 531 may be electrically disconnected from the connection portion 532 and stay disconnected. In aspects, the connection portion 531 and/or the connection portion 532 may be configured with materials, constructions, arrangements, configurations, and/or the like such that the connection portion 531 may be electrically disconnected from the connection portion 532 and stay disconnected.

In aspects, the connection portion 531 and/or the connection portion 532 may be configured such that the connection portion 531 may be electrically disconnected from the connection portion 532 and subsequently reconnect. In aspects, the connection portion 531 and/or the connection portion 532 may be configured with materials, constructions, arrangements, configurations, and/or the like such that the connection portion 531 may be electrically disconnected from the connection portion 532 and subsequently reconnect.

In aspects, the connection portion 532 of the second connection structure 502 may be arranged above the connection portion 531 of the first connection structure 501, the body portion 521 of the first connection structure 501, the attachment portion 511 of the first connection structure 501, and/or the like.

In aspects, the attachment portion 512 of the second connection structure 502 may be arranged below the connection portion 531 of the first connection structure 501, the body portion 521 of the first connection structure 501, the attachment portion 511 of the first connection structure 501, and/or the like.

FIG. 6 illustrates the solid state circuit breaker 100 together with the at least one fail-open mechanism 110 of FIG. 5 during current surge and/or overheating. In aspects, during a fault operation, the solid state circuit breaker 100 may interrupt current flow between the power source 306 and the load 304. In particular, the solid state circuit breaker 100 may electrically disconnect the power source 306 from the load 304. Accordingly, the solid state circuit breaker 100 may limit overcurrent between the power source 306 and the load 304 and protect the power source 306 and the load 304 from damage.

However, should the solid state circuit breaker 100 fail and/or not interrupt current flow between the power source 306 and the load 304 during a fault operation, the at least one fail-open mechanism 110 implementing the first connection structure 501 and the second connection structure 502 may provide a physical fail-open mechanism to ensure a physical air-gap in case of extreme current surges resulting in device failures.

In particular, when the system 300 experiences a fault scenario, the solid state circuit breaker 100 experiences a current surge and/or overheating. In this regard, a fault scenario may be non-nominal operations of the solid state circuit breaker 100, non-normal operations of the solid state circuit breaker 100, operations above a rated current of the solid state circuit breaker 100, operations with current surge through the solid state circuit breaker 100, operations with overheating of the solid state circuit breaker 100, and/or the like. Likewise, the at least one fail-open mechanism 110 experiences a current surge and/or overheating. Further, the first connection structure 501 and the second connection structure 502 experiences a current surge and/or overheating.

In particular aspects, materials forming the connection portion 531 and the connection portion 532 may have different attributes. The different attributes of the connection portion 531 and the connection portion 532 may include at least one different material, materials with different coefficients of thermal expansion (CTE), different structures, different structural configurations, different arrangements, and/or the like such that the connection portion 531 and the connection portion 532 to change shape and form an airgap therebetween.

In aspects, the connection portion 531 and the connection portion 532 may be configured with the different attributes to change shape and form an airgap therebetween during non-nominal operations of the solid state circuit breaker 100, non-normal operations of the solid state circuit breaker 100, operations above a rated current of the solid state circuit breaker 100, overcurrent operations of the solid state circuit breaker 100, operations with current surge through the solid state circuit breaker 100, operations with overheating of the solid state circuit breaker 100, and/or the like.

In aspects, the first connection structure 501 and the second connection structure 502 may be implemented as a bimetallic strip that may have two different metal bars-one, formed with the Metal 1 connected to the first pad 418, such as a source pad on the at least one power device 101 and/or the at least one second power device 102, and the other formed with a Metal 2 connected to the second pad 406, such as a source connection, a source copper trace, and/or the like in a module frame of the solid state circuit breaker 100. The Metal 1 may be configured to have a lower coefficient of thermal expansion (CTE) compared to the Metal 2. This may result in dissimilar expansion of the metal bars when heated due to current surges. Dissimilar expansion in the bimetallic strip ensures a physical air-gap.

In aspects, during normal operations, bimetallic strip halves implemented by the first connection structure 501 and the second connection structure 502 may remain connected. During current surge events, the Metal 1 and the Metal 2 may expand in opposite directions, thus ensuring a physical disconnect by the first connection structure 501 and the second connection structure 502 in the current flow path.

In aspects, the bimetallic strip may include two parts implemented by the first connection structure 501 and the second connection structure 502, each made of a single metal. One part connecting to the power terminals 114, and the other part connecting to the power semiconductor, such as the at least one power device 101 and/or the at least one second power device 102. The difference in the CTE of the two metals may cause the first connection structure 501 and the second connection structure 502 to bend away in opposite directions and create a physical air-gap.

During the current surge and/or overheating, the first connection structure 501, formed at least in part by the Metal 1 may change shape by a first amount as illustrated in FIG. 6 to form an airgap to the second connection structure 502. Further during the current surge and/or overheating, the second connection structure 502, formed at least in part by the Metal 2 may change shape by a second amount as illustrated in FIG. 6 to form an airgap to the first connection structure 501.

In particular, the first connection structure 501 may be configured to change shape including straightening, rotating, twisting, and/or the like in a manner different from the second connection structure 502. In aspects, at least the connection portion 532 of the second connection structure 502 may be configured to change shape including straightening, rotating, twisting, and/or the like. In aspects, at least the connection portion 532 of the second connection structure 502 may extend along the vertical axis 903 upwards and away from the first connection structure 501.

Further, the second connection structure 502 may be configured to change shape including straightening, rotating, twisting, and/or the like in a manner different from the first connection structure 501. In aspects, at least the connection portion 531 of the first connection structure 501 may be configured to change shape including straightening, rotating, twisting, and/or the like. In aspects, at least the connection portion 531 of the first connection structure 501 may extend along the vertical axis 903 downwards and away from the second connection structure 502.

In aspects, the change in shape by the first connection structure 501 by the first amount may be greater, different, opposite, and/or the like than the change in shape of the second connection structure 502 by the second amount.

The aspects above may ensure that both the first connection structure 501 and the second connection structure 502 physically disconnect under extreme currents that cause overheating. Aspects of the solid state circuit breaker 100 and/or the at least one fail-open mechanism 110 described in relation to FIGS. 5-6 may optionally be implemented in any other aspects of the solid state circuit breaker 100 and/or the at least one fail-open mechanism 110 described and/or illustrated herein. Moreover, aspects of the solid state circuit breaker 100 and/or the at least one fail-open mechanism 110 described and/or illustrated herein may optionally be implemented in the aspects of the solid state circuit breaker 100 and/or the at least one fail-open mechanism 110 illustrated in FIGS. 5-6 and described therewith.

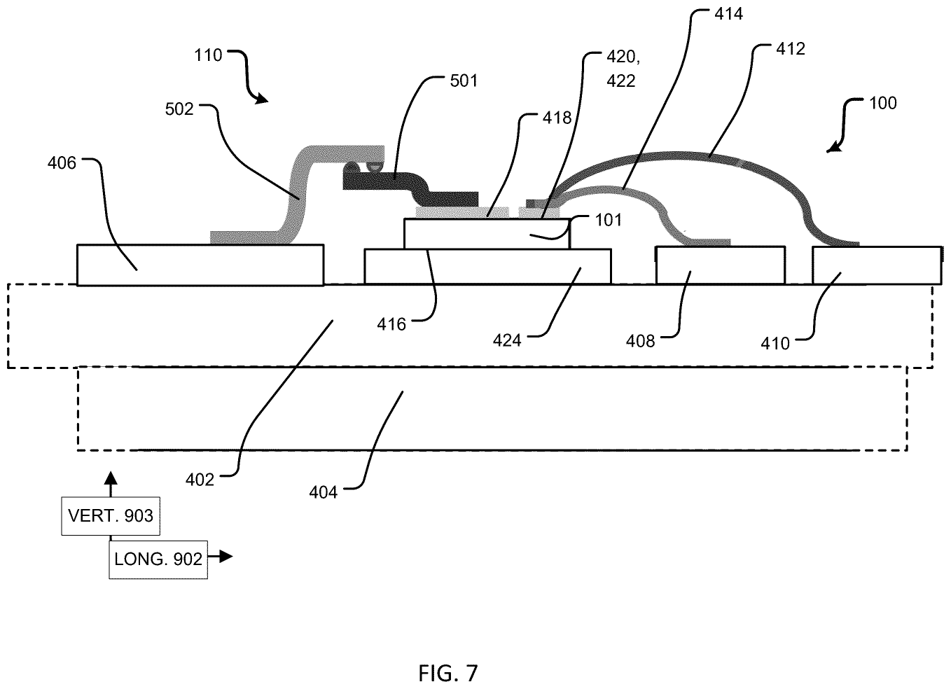

FIG. 7 illustrates a side view with further exemplary details of the solid state circuit breaker together with an exemplary implementation of the at least one fail-open mechanism according to FIG. 5 during nominal operations.

In particular, FIG. 7 illustrates further exemplary details of the solid state circuit breaker 100 together with an exemplary implementation of the at least one fail-open mechanism 110 according to FIG. 5 during nominal operations. In aspects, the solid state circuit breaker 100 may include the at least one power device 101 and the at least one fail-open mechanism 110 implementing the first connection structure 501 and the second connection structure 502 as previously described.

In aspects, the solid state circuit breaker 100 may further include a substrate 402, a baseplate 404, the second pad 406, a breaker Kevin source pad 408, a breaker gate pad 410, a breaker drain pad 424, a gate—device interconnect 412, a Kevin source—device interconnect 414, and/or the like. In aspects, the second pad 406 may be implemented as a breaker source pad of the solid state circuit breaker 100.

In aspects, the at least one power device 101 may include a device drain pad 416, the first pad 418, a device gate pad 420, a device Kevin source pad 422, and/or the like. The first pad 418 may be implemented as a device source pad of the at least one power device 101 and/or the at least one second power device 102.

In aspects, the breaker Kevin source pad 408 may be connected to the device Kevin source pad 422 through the Kevin source—device interconnect 414. In aspects, the breaker gate pad 410 may be connected to the device gate pad 420 through the gate—device interconnect 412.

Aspects of the solid state circuit breaker 100 and/or the at least one fail-open mechanism 110 described in relation to FIG. 7 may optionally be implemented in any other aspects of the solid state circuit breaker 100 and/or the at least one fail-open mechanism 110 described and/or illustrated herein. Moreover, aspects of the solid state circuit breaker 100 and/or the at least one fail-open mechanism 110 described and/or illustrated herein may optionally be implemented in the aspects of the solid state circuit breaker 100 and/or the at least one fail-open mechanism 110 illustrated in FIG. 7 and described therewith.

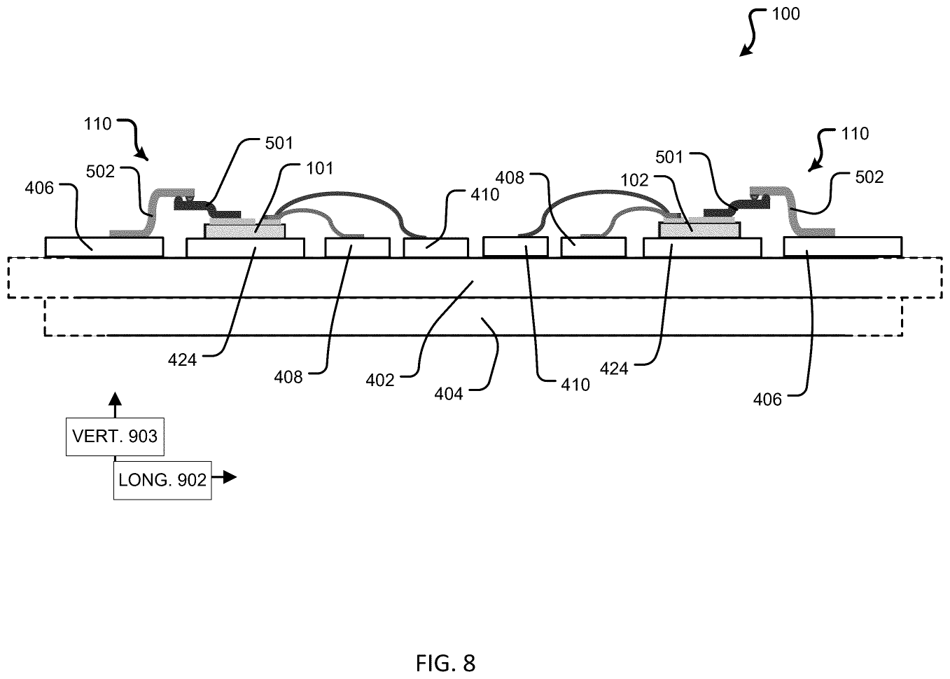

FIG. 8 illustrates a side view with further exemplary details of the solid state circuit breaker together with an exemplary implementation of the at least one fail-open mechanism according to FIG. 5 during nominal operations.

In particular, FIG. 8 illustrates further exemplary details of the solid state circuit breaker 100 together with an exemplary implementation of the at least one fail-open mechanism 110 according to FIG. 5 during nominal operations. In aspects, the solid state circuit breaker 100 may include the at least one power device 101 and multiple implementations of the at least one fail-open mechanism 110 each implementing the first connection structure 501 and the second connection structure 502 as previously described.

In aspects, the solid state circuit breaker 100 may include multiple implementations of one or more of the second pad 406, the breaker Kevin source pad 408, the breaker gate pad 410, the breaker drain pad 424, the gate—device interconnect 412, the Kevin source—device interconnect 414, and/or the like.

In aspects, the at least one power device 101 and/or the at least one second power device 102 may include the device drain pad 416, the first pad 418, the device gate pad 420, the device Kevin source pad 422, and/or the like.

In aspects, the solid state circuit breaker 100 may include encapsulation 180 as illustrated in FIG. 5 and FIG. 6. In this regard, the encapsulation 180 may be configured to provide cooling sufficient to ensure a connection between the first connection structure 501 and the second connection structure 502 during a normal expected range of currents. Further in this aspect, the encapsulation 180 may be configured to allow for movement of the at least one fail-open mechanism 110. In particular, the encapsulation 180 may be configured to allow for movement of the first connection structure 501 and the second connection structure 502 during extreme surge currents so that source disconnect happens due to unequal thermal expansion of clip halves.

In aspects, the encapsulation 180 may partially enclose and/or cover one or more of the first connection structure 501, the second connection structure 502, and/or the like. In aspects, the encapsulation 180 may partially enclose and/or cover one or more of the attachment portion 512 of the second connection structure 502, the body portion 522 of the second connection structure 502, the connection portion 532 of the second connection structure 502, the attachment portion 511 of the first connection structure 501, the body portion 521 of the first connection structure 501, the connection portion 531 of the first connection structure 501, and/or the like.

In aspects, the encapsulation 180 may be arranged separate from one or more of the first connection structure 501, the second connection structure 502, and/or the like. In aspects, the encapsulation 180 may be arranged separate from one or more of the attachment portion 512, the body portion 522, the connection portion 532, the attachment portion 511, the body portion 521, the connection portion 531, and/or the like.

Aspects of the solid state circuit breaker 100 and/or the at least one fail-open mechanism 110 described in relation to FIG. 8 may optionally be implemented in any other aspects of the solid state circuit breaker 100 and/or the at least one fail-open mechanism 110 described and/or illustrated herein. Moreover, aspects of the solid state circuit breaker 100 and/or the at least one fail-open mechanism 110 described and/or illustrated herein may optionally be implemented in the aspects of the solid state circuit breaker 100 and/or the at least one fail-open mechanism 110 illustrated in FIG. 8 and described therewith.

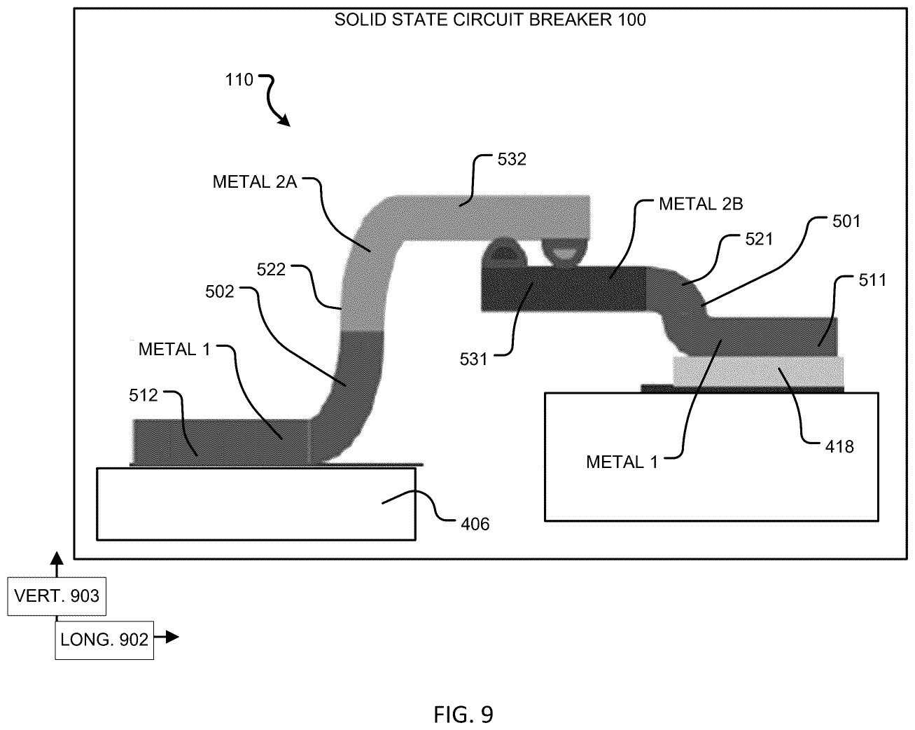

FIG. 9 illustrates a side view with further details of the solid state circuit breaker together with an exemplary implementation of the at least one fail-open mechanism according to aspects of the disclosure during nominal operations.

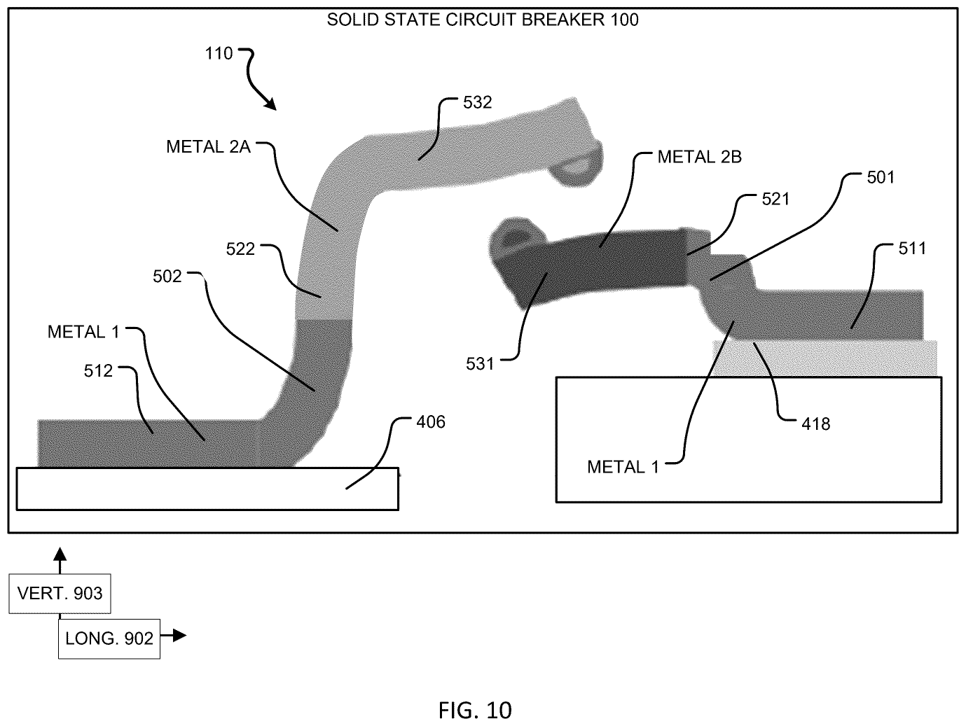

FIG. 10 illustrates a side view with further details of the solid state circuit breaker together with the exemplary implementation of the at least one fail-open mechanism of FIG. 9 during current surge and/or overheating.

In particular, FIG. 9 illustrates further details of the solid state circuit breaker 100 together with an exemplary implementation of the at least one fail-open mechanism 110 according to aspects of the disclosure during nominal operations. In aspects, the solid state circuit breaker 100 may include the at least one fail-open mechanism 110 as previously described. In aspects, the first connection structure 501 may be configured as a bimetallic clip made of two pieces jointed along its length. In aspects, the second connection structure 502 may be configured as a bimetallic clip made of two pieces jointed along its length.

In aspects, the solid state circuit breaker 100 may include the first pad 418, the second pad 406, the first connection structure 501, the second connection structure 502, and/or the like as previously described. In aspects, the first connection structure 501 may include the attachment portion 511, the body portion 521, the connection portion 531, and/or the like as previously described. In aspects, the second connection structure 502 may include the attachment portion 512, the body portion 522, the connection portion 532, and/or the like as previously described.

In aspects, the first connection structure 501 and the second connection structure 502 may be formed at least in part by a same material. In aspects, the first connection structure 501 and the second connection structure 502 may be formed at least in part by different materials. In aspects, the first connection structure 501 may be formed at least in part by a Metal 1; and the second connection structure 502 may be formed at least in part by a Metal 1. In aspects, the first connection structure 501 may be formed at least in part by the Metal 1; and the second connection structure 502 may be formed at least in part by the Metal 2.

In aspects, the body portion 522 and/or the connection portion 532 may be formed at least in part by a Metal 2A having a coefficient of thermal expansion (CTE). In aspects, the Metal 2A may include one or more metals, metal alloys, shape memory materials, shape memory alloys, memory metals, memory alloys, smart metals, smart alloys, muscle wires, and/or the like.

In aspects, the body portion 521 and/or the connection portion 531 may be formed at least in part by a Metal 2B having a coefficient of thermal expansion (CTE). In aspects, the Metal 2B may include one or more metals, metal alloys, shape memory materials, shape memory alloys, memory metals, memory alloys, smart metals, smart alloys, muscle wires, and/or the like.

In aspects, a coefficient of thermal expansion (CTE) of the body portion 521 and/or the connection portion 531 may be different than a coefficient of thermal expansion (CTE) of the body portion 522 and/or the connection portion 532.

In aspects, a coefficient of thermal expansion (CTE) of the body portion 521 and/or the connection portion 531 may be less than a coefficient of thermal expansion (CTE) of the body portion 522 and/or the connection portion 532.

FIG. 10 illustrates the solid state circuit breaker 100 together with the at least one fail-open mechanism 110 of FIG. 9 during current surge and/or overheating.

In aspects, during a fault operation, the solid state circuit breaker 100 may interrupt current flow between the power source 306 and the load 304. In particular, the solid state circuit breaker 100 may electrically disconnect the power source 306 from the load 304. Accordingly, the solid state circuit breaker 100 may limit overcurrent between the power source 306 and the load 304 and protect the power source 306 and the load 304 from damage.

However, should the solid state circuit breaker 100 fail and/or not interrupt current flow between the power source 306 and the load 304 during a fault operation, the at least one fail-open mechanism 110 implementing the first connection structure 501 and the second connection structure 502 may provide a physical fail-open mechanism to ensure a physical air-gap in case of extreme current surges resulting in device failures.

In particular, when the system 300 experiences a fault scenario, the solid state circuit breaker 100 experiences a current surge and/or overheating. Likewise, the at least one fail-open mechanism 110 experiences a current surge and/or overheating. Further, the first connection structure 501 and the second connection structure 502 experiences a current surge and/or overheating.

In aspects, the body portion 521, the connection portion 531, the body portion 522, and/or the connection portion 532 may be implemented as a bimetallic strip that may have two different metal bars-one, formed with the Metal 2A and the other formed with a Metal 2B. The Metal 2B may be designed to have a lower coefficient of thermal expansion (CTE) compared to the Metal 2A. This may result in dissimilar expansion of the metal bars when heated due to current surges. Dissimilar expansion in the bimetallic strip ensures a physical air-gap.

In aspects, during normal operations, bimetallic strip halves implemented by the body portion 521, the connection portion 531, the body portion 522, and/or the connection portion 532 may remain connected. During current surge events, the Metal 2A and the Metal 2B may expand in opposite directions, thus ensuring a physical disconnect by the first connection structure 501 and the second connection structure 502 in the current flow path. The difference in the CTE of the two metals may cause the first connection structure 501 and the second connection structure 502 to bend away in opposite directions and create a physical air-gap.

During the current surge and/or overheating, the body portion 521 and/or the connection portion 531, formed at least in part by the Metal 2A that has a coefficient of thermal expansion (CTE), may change shape by a first amount as illustrated in FIG. 10.

Further during the current surge and/or overheating, the body portion 522 and/or the connection portion 532, formed at least in part by the Metal 2B that has a coefficient of thermal expansion (CTE), may change shape by a second amount as illustrated in FIG. 10.

In particular, the first connection structure 501 may be configured to change shape including straightening, rotating, twisting, and/or the like in a manner different from the second connection structure 502. In aspects, at least the connection portion 532 of the second connection structure 502 may extend along the vertical axis 903 upwards and away from the first connection structure 501.

Further, the second connection structure 502 may be configured to change shape including straightening, rotating, twisting, and/or the like in a manner different from the first connection structure 501. In aspects, at least the connection portion 531 of the first connection structure 501 may extend along the vertical axis 903 downwards and away from the second connection structure 502.

In aspects, the change in shape by the first connection structure 501 by the first amount may be greater, different, opposite, and/or the like than the change in shape of the second connection structure 502 by the second amount.

The aspects above may ensure that both the first connection structure 501 and the second connection structure 502 physically disconnect under extreme currents that cause overheating.

Aspects of the solid state circuit breaker 100 and/or the at least one fail-open mechanism 110 described in relation to FIG. 9 and FIG. 10 may optionally be implemented in any other aspects of the solid state circuit breaker 100 and/or the at least one fail-open mechanism 110 described and/or illustrated herein. Moreover, aspects of the solid state circuit breaker 100 and/or the at least one fail-open mechanism 110 described and/or illustrated herein may optionally be implemented in the aspects of the solid state circuit breaker 100 and/or the at least one fail-open mechanism 110 illustrated in FIG. 9 and FIG. 10 and described therewith.

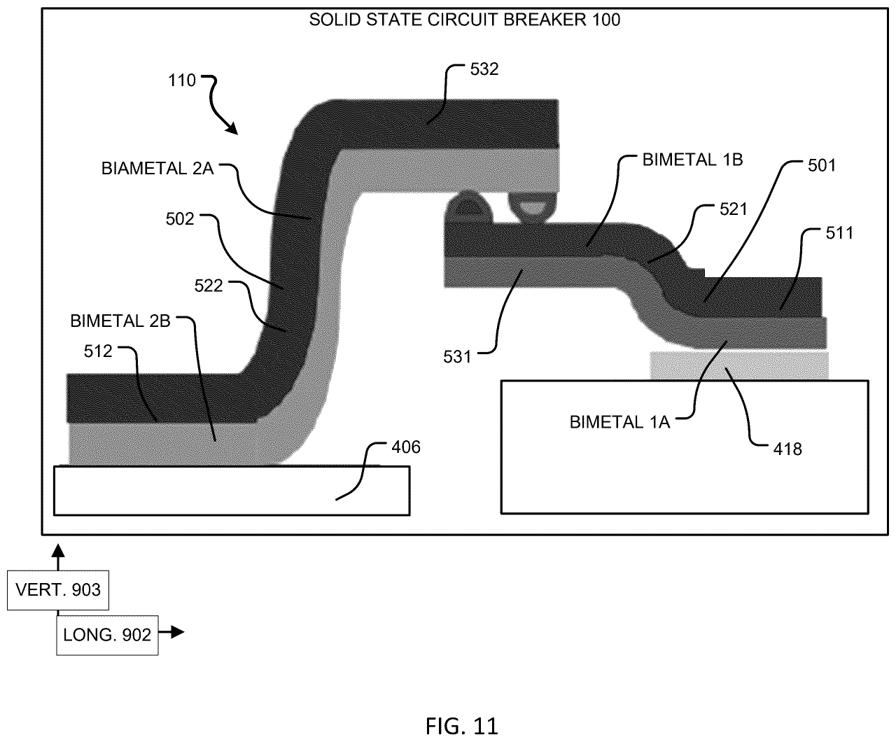

FIG. 11 illustrates a side view with further details of the solid state circuit breaker together with an exemplary implementation of the at least one fail-open mechanism according to aspects of the disclosure during nominal operations.

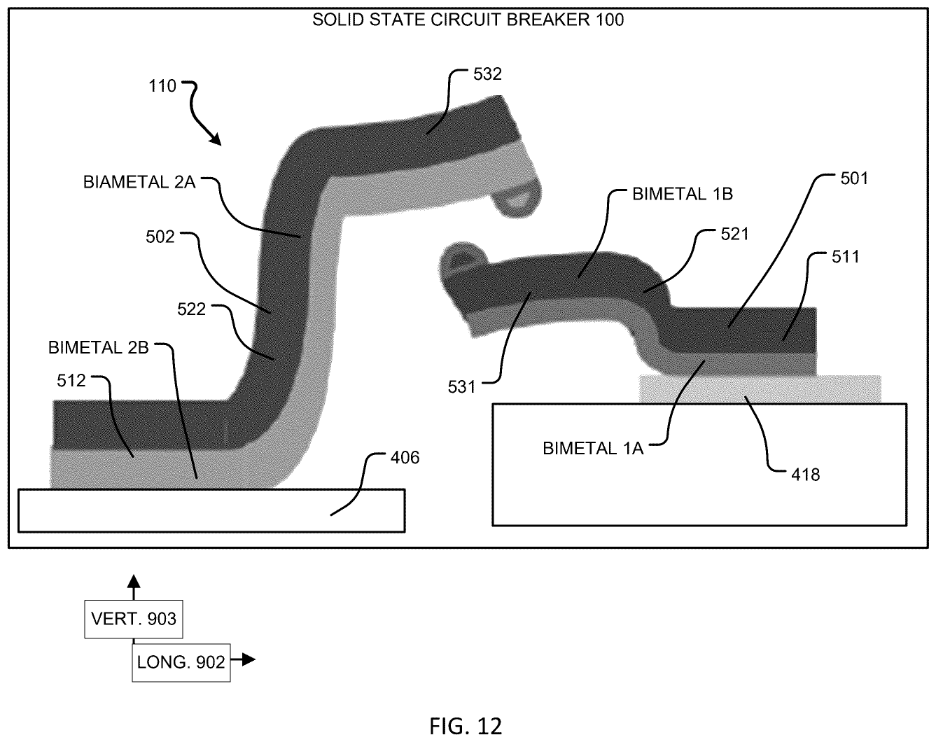

FIG. 12 illustrates a side view with further details of the solid state circuit breaker together with the exemplary implementation of the at least one fail-open mechanism of FIG. 11 during current surge and/or overheating.

In particular, FIG. 11 illustrates further details of the solid state circuit breaker 100 together with an exemplary implementation of the at least one fail-open mechanism 110 according to aspects of the disclosure during nominal operations. In aspects, the solid state circuit breaker 100 may include the at least one fail-open mechanism 110 as previously described. In aspects, the at least one fail-open mechanism 110 may be configured as a bimetallic clip, a bimetallic structure, a bimetallic connection, and/or the like.

In aspects, the solid state circuit breaker 100 may include the first pad 418, the second pad 406, the first connection structure 501, the second connection structure 502, and/or the like as previously described. In aspects, the first connection structure 501 may include the attachment portion 511, the body portion 521, the connection portion 531, and/or the like as previously described. In aspects, the second connection structure 502 may include the attachment portion 512, the body portion 522, the connection portion 532, and/or the like as previously described.

In aspects, the first connection structure 501 may be formed at least in part by a Metal 1A and a Metal 1B. In aspects, an upper portion of the first connection structure 501 may be formed at least in part by the Metal 1B. In aspects, a lower portion of the first connection structure 501 may be formed at least in part by a Metal 1A.

The Metal 1A may be configured to have a coefficient of thermal expansion (CTE). In aspects, the Metal 1A may include one or more metals, metal alloys, shape memory materials, shape memory alloys, memory metals, memory alloys, smart metals, smart alloys, muscle wires, and/or the like.

The Metal 1B may be configured to have a coefficient of thermal expansion (CTE). In aspects, the Metal 1B may include one or more metals, metal alloys, shape memory materials, shape memory alloys, memory metals, memory alloys, smart metals, smart alloys, muscle wires, and/or the like.

In aspects, the second connection structure 502 may be formed at least in part by a Metal 2A and a Metal 2B.

In aspects, an upper portion of the second connection structure 502 may be formed at least in part by a Metal 2A.

In aspects, a lower portion of the second connection structure 502 may be formed at least in part by a Metal 2B.

The Metal 2A may be configured to have a coefficient of thermal expansion (CTE). In aspects, the Metal 2A may include one or more metals, metal alloys, shape memory materials, shape memory alloys, memory metals, memory alloys, smart metals, smart alloys, muscle wires, and/or the like.

The Metal 2B may include one or more metals, metal alloys, shape memory materials, shape memory alloys, memory metals, memory alloys, smart metals, smart alloys, muscle wires, and/or the like.

In aspects, the Metal 1A may have a different coefficient of thermal expansion (CTE) compared to the Metal 1B. In other words, a coefficient of thermal expansion (CTE) of the first connection structure 501 may be different than a coefficient of thermal expansion (CTE) of the first connection structure 501.

In aspects, the Metal 1A may have a lower coefficient of thermal expansion (CTE) compared to the Metal 1B. In other words, a coefficient of thermal expansion (CTE) of the first connection structure 501 may be lower than a coefficient of thermal expansion (CTE) of the first connection structure 501.

In aspects, the Metal 2A may have a different coefficient of thermal expansion (CTE) compared to the Metal 2B. In other words, a coefficient of thermal expansion (CTE) of a lower portion of the second connection structure 502 may be different than a coefficient of thermal expansion (CTE) of an upper portion of the second connection structure 502.

In aspects, the Metal 2A may have a lower coefficient of thermal expansion (CTE) compared to the Metal 2B. In other words, a coefficient of thermal expansion (CTE) of a lower portion of the second connection structure 502 may be lower than a coefficient of thermal expansion (CTE) of an upper portion of the second connection structure 502.

FIG. 12 illustrates the solid state circuit breaker 100 together with the at least one fail-open mechanism 110 of FIG. 11 during current surge and/or overheating.

In aspects, during a fault operation, the solid state circuit breaker 100 may interrupt current flow between the power source 306 and the load 304. In particular, the solid state circuit breaker 100 may electrically disconnect the power source 306 from the load 304. Accordingly, the solid state circuit breaker 100 may limit overcurrent between the power source 306 and the load 304 and protect the power source 306 and the load 304 from damage.

However, should the solid state circuit breaker 100 fail and/or not interrupt current flow between the power source 306 and the load 304 during a fault operation, the at least one fail-open mechanism 110 implementing the first connection structure 501 and the second connection structure 502 may provide a physical fail-open mechanism to ensure a physical air-gap in case of extreme current surges resulting in device failures.

In particular, when the system 300 experiences a fault scenario, the solid state circuit breaker 100 experiences a current surge and/or overheating. Likewise, the at least one fail-open mechanism 110 experiences a current surge and/or overheating. Further, the first connection structure 501 and the second connection structure 502 experiences a current surge and/or overheating.

In aspects, the first connection structure 501 may be implemented as a bimetallic strip that may have two different metal bars-one, formed with the Metal 1A and Metal 1B; and the second connection structure 502 may be implemented as a bimetallic strip that may have two different metal bars-one, formed with the Metal 2A and Metal 2B. This may result in dissimilar expansion of the metal bars when heated due to current surges. Dissimilar expansion in the bimetallic strip ensures a physical air-gap.

In aspects, during normal operations, bimetallic strip halves implemented by the first connection structure 501 and the second connection structure 502 may remain connected. During current surge events, the Metal 1A and Metal 1B and the Metal 2A and Metal 2B may expand in opposite directions, thus ensuring a physical disconnect by the first connection structure 501 and the second connection structure 502 in the current flow path.

During the current surge and/or overheating, the first connection structure 501, formed as noted above may be configured to change shape by a first amount as illustrated in FIG. 12.

Further during the current surge and/or overheating, the second connection structure 502, formed as noted above may change shape by a second amount as illustrated in FIG. 12.

In particular, the first connection structure 501 may be configured to change shape including straightening, rotating, twisting, and/or the like in a manner different from the second connection structure 502. In aspects, at least the connection portion 532 of the second connection structure 502 may extend along the vertical axis 903 upwards and away from the first connection structure 501.

Further, the second connection structure 502 may be configured to change shape including straightening, rotating, twisting, and/or the like in a manner different from the first connection structure 501. In aspects, at least the connection portion 531 of the first connection structure 501 may extend along the vertical axis 903 downwards and away from the second connection structure 502.

In aspects, the change in shape by the first connection structure 501 by the first amount may be greater, different, opposite, and/or the like than the change in shape of the second connection structure 502 by the second amount.

The aspects above may ensure that both the first connection structure 501 and the second connection structure 502 physically disconnect under extreme currents that cause overheating.

Aspects of the solid state circuit breaker 100 and/or the at least one fail-open mechanism 110 described in relation to FIG. 11 and FIG. 12 may optionally be implemented in any other aspects of the solid state circuit breaker 100 and/or the at least one fail-open mechanism 110 described and/or illustrated herein. Moreover, aspects of the solid state circuit breaker 100 and/or the at least one fail-open mechanism 110 described and/or illustrated herein may optionally be implemented in the aspects of the solid state circuit breaker 100 and/or the at least one fail-open mechanism 110 illustrated in FIG. 11 and FIG. 12 and described therewith.

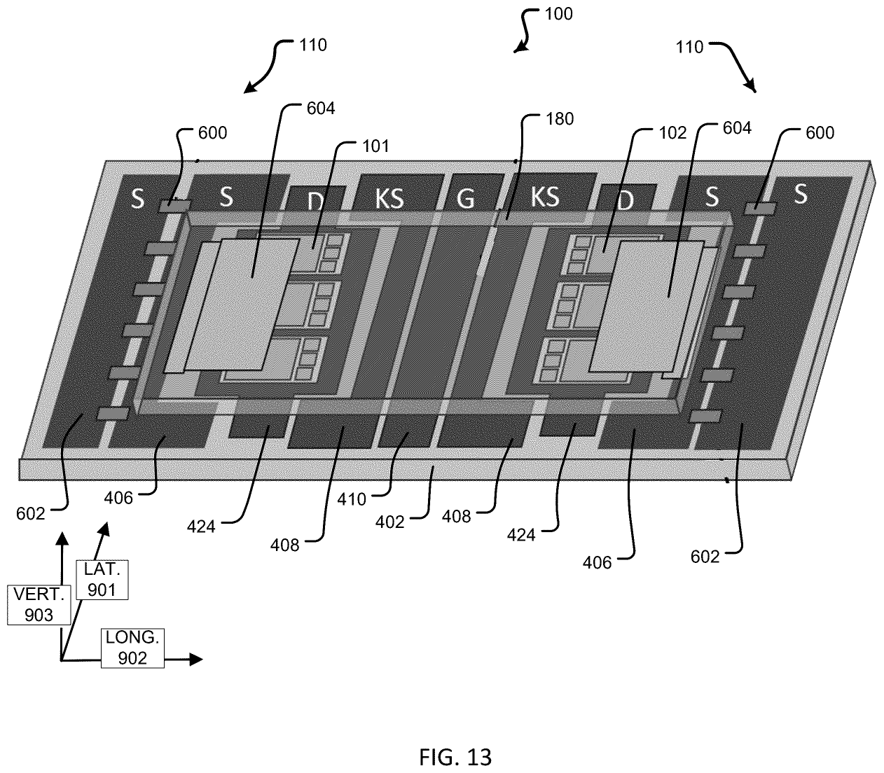

FIG. 13 illustrates a perspective view with further details of the solid state circuit breaker together with an exemplary implementation of the at least one fail-open mechanism according to aspects of the disclosure.

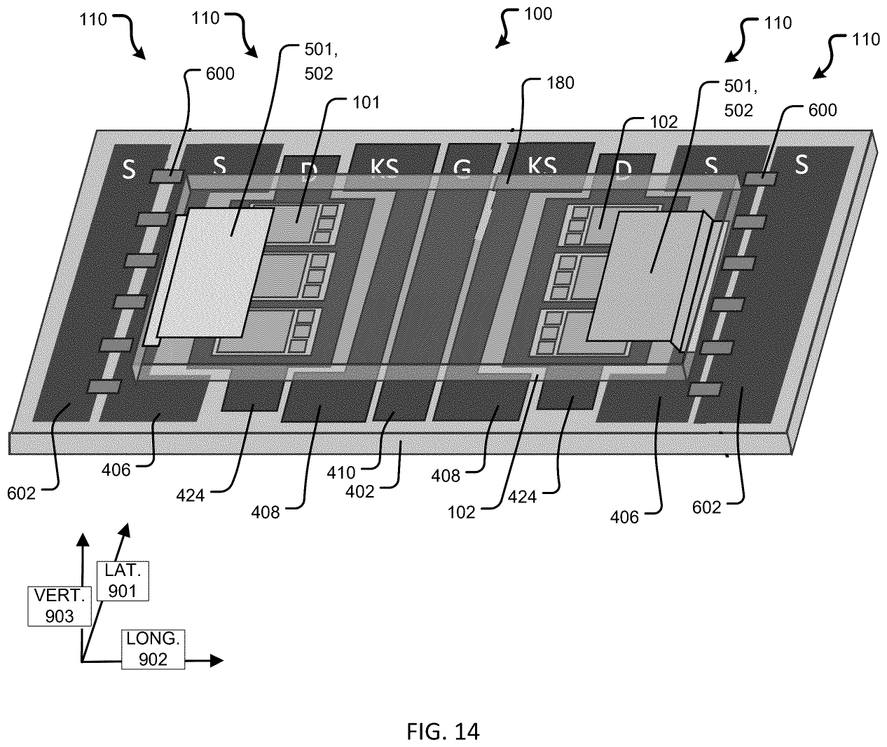

FIG. 14 illustrates a perspective view with further details of the solid state circuit breaker together with an exemplary implementation of the at least one fail-open mechanism according to aspects of the disclosure.

In particular, FIG. 13 illustrates further details of the solid state circuit breaker 100 together with an exemplary implementation of the at least one fail-open mechanism 110 according to aspects of the disclosure during nominal operations. In aspects, the solid state circuit breaker 100 may include the at least one fail-open mechanism 110 as previously described. In aspects, the at least one fail-open mechanism 110 may be implemented as at least one fuse 600.

In aspects, the at least one fuse 600 may be implemented as a micro fuse, a plurality of micro fuses, a metal strip, a wire fuse element, and/or the like. In aspects, the solid state circuit breaker 100 may include at least one additional pad 602.

In aspects, the solid state circuit breaker 100 may be implemented with the at least one fail-open mechanism 110 configured as the at least one fuse 600 without any implementation of the at least one fail-open mechanism 110 configured with the first connection structure 501 and the second connection structure 502 as illustrated in FIG. 13. In other aspects, the solid state circuit breaker 100 may be implemented with the at least one fail-open mechanism 110 configured as the at least one fuse 600 together with implementation of the at least one fail-open mechanism 110 configured with the first connection structure 501 and the second connection structure 502 as illustrated in FIG. 14.

In aspects, the solid state circuit breaker 100 may implement a plurality of paralleled implementations of the at least one fuse 600, a plurality of paralleled micro fuse implementations of the at least one fuse 600, an array of the at least one fuse 600, and/or the like. In particular, the solid state circuit breaker 100 may implement a plurality of paralleled implementations of the at least one fuse 600 arranged along a lateral axis 901.

Further, FIG. 13 and FIG. 14 illustrate an implementation of the solid state circuit breaker 100 that may implement a plurality of paralleled implementations of the at least one power device 101 and the at least one second power device 102 arranged along a lateral axis 901. However, in other aspects the solid state circuit breaker 100 that may implement one implementation of the at least one power device 101, one implementation the at least one power device 101 and one implementation the at least one second power device 102, and/or the like

With reference to FIG. 13, without implementation of the first connection structure 501 and the second connection structure 502, the second pad 406 may be connected to the at least one power device 101 with an interconnect 604. In aspects, the interconnect 604 may be at least one metal clip, paralleled wire bonds, a ribbon, and/or the like.

In aspects, encapsulation 180 may be placed to enclose all the objects between the at least one fuse 600 placement arrays.

In aspects, the at least one fuse 600 may be configured to create a physical gap. In aspects, the at least one fuse 600 may be configured to be replaced without interfering with components of the solid state circuit breaker 100 including the at least one power device 101, the at least one second power device 102, an inner copper portion, a semiconductor assembly, and/or the like.

In aspects of the solid state circuit breaker 100, power terminals may be wire-bonded, directly soldered, connected through metal-clips, and/or the like. In aspects of the solid state circuit breaker 100, signal terminals may be wire-bonded, directly soldered, connected through metal-clips, and/or the like.

In aspects, the breaker Kevin source pad 408, the breaker gate pad 410, others terminals, and/or the like may be formed of copper pads. In aspects, the breaker Kevin source pad 408, the breaker gate pad 410, others terminals, and/or the like may be connected through ribbons, screws, pins, and/or the like and may use extended areas outside the encapsulation 180 and/or encapsulated region.

With reference to FIG. 14, the solid state circuit breaker 100 may be further configured with an additional implementation of the at least one fail-open mechanism 110 implemented with the first connection structure 501 and the second connection structure 502. In this aspect, the at least one fail-open mechanism 110 implemented with the first connection structure 501 and the second connection structure 502 may include any of the configurations of the first connection structure 501 and the second connection structure 502 as described herein.

In aspects, the solid state circuit breaker 100 may be configured so as to fail open by implementation of the at least one fail-open mechanism 110 configured as the at least one fuse 600. Thereafter, the solid state circuit breaker 100 may be reconfigured to operate after replacing the at least one fuse 600.

In aspects, the solid state circuit breaker 100 may be configured so as to fail open and stay open by implementation of the at least one fail-open mechanism 110 configured as the at least one fuse 600. In other words, not replacing the at least one fuse 600.

In aspects, the solid state circuit breaker 100 may be configured to inspect semiconductor device health including health of the at least one power device 101 and the at least one second power device 102 by testing the power and signal terminals.

In aspects, the at least one fuse 600 may include a fuse element that includes zinc, copper, silver, aluminum, and/or the like or alloys thereof. In aspects, the at least one fuse 600 may include a pair of electrical terminals and the solid state circuit breaker 100 may include a corresponding set pair of electrical terminals.

In aspects, the corresponding set pair of electrical terminals of the solid state circuit breaker 100 may be attached to the solid state circuit breaker 100 by a solder connection, an adhesive connection, and/or the like.

In aspects, during a fault operation, the solid state circuit breaker 100 may interrupt current flow between the power source 306 and the load 304. In particular, the solid state circuit breaker 100 may electrically disconnect the power source 306 from the load 304. Accordingly, the solid state circuit breaker 100 may limit overcurrent between the power source 306 and the load 304 and protect the power source 306 and the load 304 from damage.

However, should the solid state circuit breaker 100 fail and/or not interrupt current flow between the power source 306 and the load 304 during a fault operation, the at least one fail-open mechanism 110 implementing the at least one fuse 600 may provide a physical fail-open mechanism to ensure a physical air-gap in case of extreme current surges resulting in device failures.

In particular, when the system 300 experiences a fault scenario, the solid state circuit breaker 100 experiences a current surge and/or overheating. Likewise, the at least one fail-open mechanism 110 experiences a current surge and/or overheating. Further, the at least one fuse 600 experiences a current surge and/or overheating, which results in the fuse element of the at least one fuse 600 rising to a higher temperature and a portion of the at least one fuse 600 may melt to form a physical air-gap.

Aspects of the solid state circuit breaker 100 and/or the at least one fail-open mechanism 110 described and/or illustrated herein may optionally be implemented in the aspects of the solid state circuit breaker 100 and/or the at least one fail-open mechanism 110 illustrated in FIGS. 13-14 and described therewith.

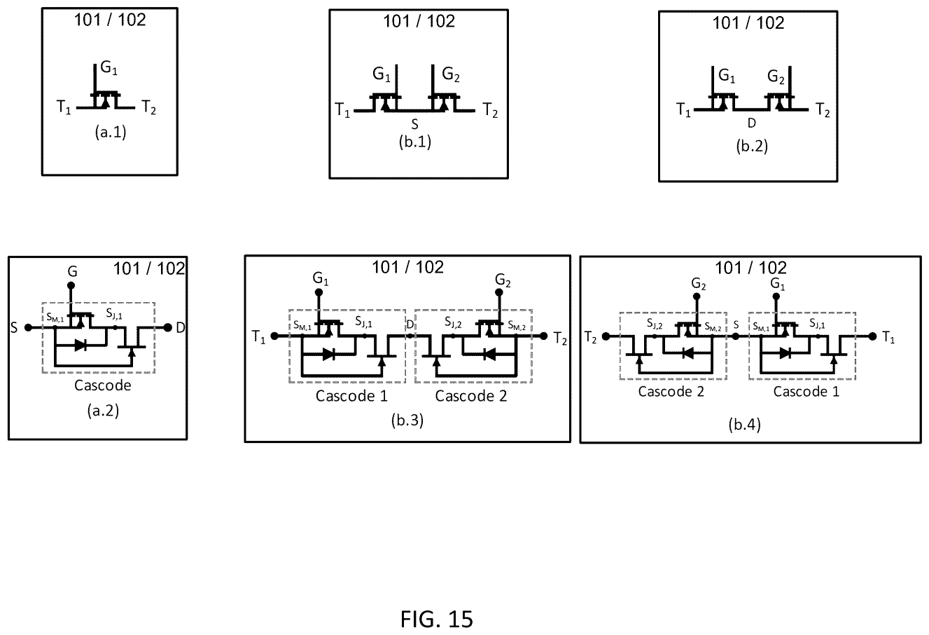

FIG. 15 illustrates schematics of exemplary implementations of the at least one power device and the at least one second power device according to aspects of the disclosure.

In particular, FIG. 15 illustrates schematics of exemplary implementations, topologies, potential switch configurations, and/or the like of the at least one power device 101 and the at least one second power device 102 that may be implemented by the solid state circuit breaker 100.

In particular, the solid state circuit breaker 100 may be configured such that at least one implementation of the at least one power device 101 and the at least one second power device 102 may be configured to be implemented as: (a.1) a single transistor for unidirectional SSCB applications; (a.2) a single composite switch for unidirectional SSCB applications; (b.1) single transistors in common-source connection for bidirectional SSCB applications; (b.2) single transistors in common-drain connection for bidirectional SSCB applications; (b.3) composite transistors in common-source connection for bidirectional SSCB applications; (b.4) composite transistors in common-drain connection for bidirectional SSCB applications; and/or the like.

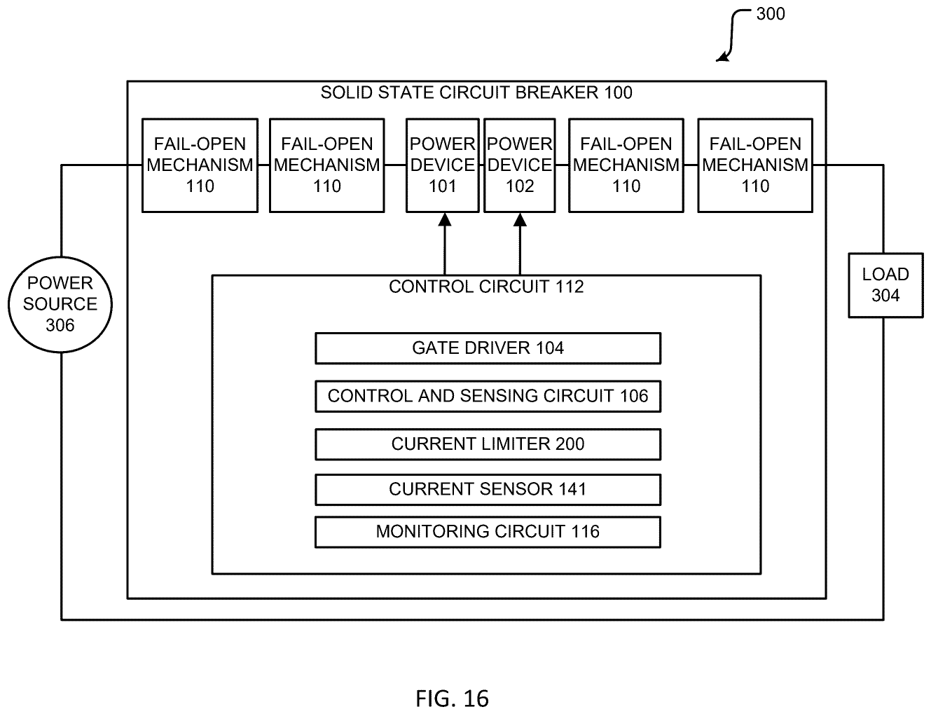

FIG. 16 illustrates an exemplary schematic of a control circuit according to aspects of the disclosure.

In particular, FIG. 16 illustrates an exemplary schematic of the control circuit 112. In aspects, the control circuit 112 may include one or more of a gate driver 104, a control and sensing circuit 106, a current limiter 200, a current sensor 141, and/or the like.

In aspects, the control circuit 112 may include a monitoring circuit 116. In aspects, the monitoring circuit 116 may be configured to monitor operation of the at least one fail-open mechanism 110. The monitoring circuit 116 may measure a number of operations, a frequency of operations, and/or the like of the at least one fail-open mechanism 110. In aspects, the monitoring circuit 116 may measure a number of operations, a frequency of operations, and/or the like of the at least one fail-open mechanism 110 by measuring a voltage of power through the solid state circuit breaker 100.

In aspects, the monitoring circuit 116 may be configured to count a number and/or a frequency of operations. In aspects, the monitoring circuit 116 may be configured to provide an indication once a number of operations exceeds a set number operations and/or the frequency of operations exceeds a set frequency of operations. In aspects, the monitoring circuit 116 may be configured to provide an indication once the number of operations exceeds the set number operations and/or the frequency of operations exceeds the set frequency of operations.

In aspects, the current sensor 141 may be implemented as a shunt resistor, a current transformer, a Rogowski coil, a magnetic field sensor, a fluxgate sensor, a magneto-resistive current sensor, and/or the like. In particular aspects, the current sensor 141 may be implemented as the shunt resistor. In aspects, the current sensor 141 may be configured to detect an overcurrent within the system 300 and/or the solid state circuit breaker 100. Further, the current sensor 141 may be configured to generate an overcurrent signal in response to an overcurrent within the system 300 and/or the solid state circuit breaker 100. In aspects, the current sensor 141 may be arranged anywhere between the power source 306 and the load 304. In aspects, the current sensor 141 may detect a current anywhere between the power source 306 and the load 304.

In aspects, during normal operation, the solid state circuit breaker 100 may electrically connect the power source 306 to the load 304. Accordingly, the solid state circuit breaker 100 may provide power from the power source 306 to the load 304 during normal operation.

In aspects, during a fault operation, the solid state circuit breaker 100 may interrupt current flow between the power source 306 and the load 304. In particular, the solid state circuit breaker 100 may electrically disconnect the power source 306 from the load 304. Accordingly, the solid state circuit breaker 100 may limit overcurrent between the power source 306 and the load 304 and protect the power source 306 and the load 304 from damage.

In particular, the current sensor 141 may be configured to sense an overcurrent between the power source 306 and the load 304. The current sensor 141 may configured to generate and provide the overcurrent signal to the control and sensing circuit 106 in response to sensing an overcurrent between the power source 306 and the load 304.

Thereafter, the control and sensing circuit 106 may generate and send a control signal to the gate driver 104 in response to the overcurrent signal. In this regard, the control and sensing circuit 106 may be configured to generate the control signal in response to the overcurrent signal.

Thereafter, the gate driver 104 may provide a gate drive signal in response to the control signal from the control and sensing circuit 106. In this regard, the gate driver 104 may be configured to generate the gate drive signal in response to the control signal.

Thereafter, in response to the gate drive signal, the at least one power device 101 and/or the at least one second power device 102 may turn off. In this regard, the at least one power device 101 and/or the at least one second power device 102 may be configured to turn off in response to the gate drive signal.

Turning off the at least one power device 101 and/or the at least one second power device 102 may disconnect the power source 306 from the load 304. Moreover, turning off the at least one power device 101 and/or the at least one second power device 102 may discontinue delivering power between the power source 306 and the load 304.

However, should the solid state circuit breaker 100 fail and/or not interrupt current flow between the power source 306 and the load 304 during a fault operation, the at least one fail-open mechanism 110 may provide a physical fail-open mechanism to ensure a physical air-gap in case of extreme current surges resulting in device failures.

In aspects, the at least one power device 101 and/or the at least one second power device 102 may be a MOSFET (Metal-Oxide-Semiconductor Field-Effect Transistor), an IGBT (Insulated-Gate Bipolar Transistor), a silicon MOSFET, a silicon IGBT, a silicon carbide (SIC) MOSFET, a silicon carbide IGBT, and/or the like. In aspects, the at least one power device 101 and/or the at least one second power device 102 may be a power transistor that may be a MOSFET (Metal-Oxide-Semiconductor Field-Effect Transistor), an IGBT (Insulated-Gate Bipolar Transistor), a silicon MOSFET, a silicon IGBT, a silicon carbide (SIC) MOSFET, a silicon carbide IGBT, and/or the like.

Further, the at least one power device 101 and/or the at least one second power device 102 may define or may be a power switch. In aspects, a power switch implementation of the at least one power device 101 and/or the at least one second power device 102 may be implemented by a single MOSFET, IGBT, silicon MOSFET, silicon IGBT, SIC MOSFET, SIC IGBT, and/or the like. In aspects, a power switch implementation of the at least one power device 101 and/or the at least one second power device 102 may be implemented by a single MOSFET.

In aspects, a composite power switch implementation of the at least one power device 101 and/or the at least one second power device 102 may be implemented by one or more MOSFETs, IGBTs, silicon MOSFETs, silicon IGBTs, SiC MOSFETs, SiC IGBTs, Junction Field Effect Transistors (JFETs), silicon Junction Field Effect Transistors (JFETs), SiC Junction Field Effect Transistors (JFETs), and/or the like. In aspects, a composite power switch implementation of the at least one power device 101 and/or the at least one second power device 102 may be implemented by a cascode of one or more MOSFETs, IGBTs, silicon MOSFETs, silicon IGBTs, SiC MOSFETs, SiC IGBTs, Junction Field Effect Transistors (JFETs), silicon Junction Field Effect Transistors (JFETs), SiC Junction Field Effect Transistors (JFETs), and/or the like. In aspects, a composite power switch implementation of the at least one power device 101 and/or the at least one second power device 102 may be implemented by a cascode of a silicon MOSFET and a SiC Junction Field Effect Transistor (JFET), and/or the like.

Accordingly, the disclosure has set forth a solid-state circuit breaker configured to ensure an open circuit in case of faults. Further, the disclosure has set forth process of implementing a solid-state circuit breaker configured to ensure an open circuit in case of faults.

The following are a number of nonlimiting EXAMPLES of aspects of the disclosure.

One EXAMPLE: a solid state circuit breaker includes at least one power device. The solid state circuit breaker in addition includes a control circuit configured to detect a fault and further configured to control operation of the at least one power device to open and electrically disconnect a power source from a load. The solid state circuit breaker moreover includes at least one fail-open device.

The above-noted EXAMPLE may further include any one or a combination of more than one of the following EXAMPLES: The solid state circuit breaker of the above-noted EXAMPLE where the at least one fail-open device is configured to provide a physical disconnect in case of failure of the at least one power device and/or the control circuit. The solid state circuit breaker of the above-noted EXAMPLE where the at least one fail-open device is configured to provide a physical air-gap in case failure of the at least one power device and/or the control circuit. The solid state circuit breaker of the above-noted EXAMPLE where the at least one fail-open device comprises at least one fuse. The solid state circuit breaker of the above-noted EXAMPLE where the at least one fail-open device comprises a plurality of paralleled implementations of the at least one fuse. The solid state circuit breaker of the above-noted EXAMPLE includes an encapsulation configured to provide cooling, where the encapsulation is configured to allow access to the at least one fuse. The solid state circuit breaker of the above-noted EXAMPLE includes: at least one second power device; and another implementation of the at least one fuse. The solid state circuit breaker of the above-noted EXAMPLE where the at least one fail-open device comprises at least one fuse configured to provide a physical air-gap in case of failure of the at least one power device and/or the control circuit. The solid state circuit breaker of the above-noted EXAMPLE where the at least one fail-open device comprises a first connection structure and a second connection structure. The solid state circuit breaker of the above-noted EXAMPLE where the at least one fail-open device comprises a first connection structure and a second connection structure configured to provide a physical air-gap in case of failure of the at least one power device and/or the control circuit. The solid state circuit breaker of the above-noted EXAMPLE where the first connection structure is configured to be electrically connected to the second connection structure during at or below a rated current of the solid state circuit breaker. The solid state circuit breaker of the above-noted EXAMPLE where a connection between the first connection structure and the second connection structure is implemented by a mechanical interaction and/or mechanical arrangement between the first connection structure and the second connection structure. The solid state circuit breaker of the above-noted EXAMPLE where the first connection structure is configured to be electrically disconnected from the second connection structure during operations above a rated current of the solid state circuit breaker. The solid state circuit breaker of the above-noted EXAMPLE where the second connection structure is at least in part above the first connection structure. The solid state circuit breaker of the above-noted EXAMPLE where a coefficient of thermal expansion (CTE) of at least a part of a material of the first connection structure is different from a coefficient of thermal expansion (CTE) of at least a part of a material of the second connection structure. The solid state circuit breaker of the above-noted EXAMPLE where a coefficient of thermal expansion (CTE) of the first connection structure is less than a coefficient of thermal expansion (CTE) of the second connection structure. The solid state circuit breaker of the above-noted EXAMPLE where the first connection structure comprises an attachment portion, a body portion, and a connection portion; and where the second connection structure comprises an attachment portion, a body portion, and a connection portion. The solid state circuit breaker of the above-noted EXAMPLE where a coefficient of thermal expansion (CTE) of the body portion of the first connection structure and/or the connection portion of the first connection structure is different from a coefficient of thermal expansion (CTE) of the body portion of the second connection structure and/or the connection portion of the second connection structure. The solid state circuit breaker of the above-noted EXAMPLE where a coefficient of thermal expansion (CTE) of the body portion of the first connection structure and/or the connection portion of the first connection structure is less than a coefficient of thermal expansion (CTE) of the body portion of the second connection structure and/or the connection portion of the second connection structure. The solid state circuit breaker of the above-noted EXAMPLE where the connection portion of the second connection structure is configured to be electrically connected to the connection portion of the first connection structure. The solid state circuit breaker of the above-noted EXAMPLE where the connection portion of the second connection structure is configured to be electrically disconnected from the connection portion of the first connection structure during operations above a rated current of the solid state circuit breaker. The solid state circuit breaker of the above-noted EXAMPLE where the connection portion of the second connection structure is above the connection portion of the first connection structure. The solid state circuit breaker of the above-noted EXAMPLE includes an encapsulation configured to provide cooling, where the encapsulation is configured to allow for movement of the at least one fail-open device. The solid state circuit breaker of the above-noted EXAMPLE where the encapsulation partially encloses and/or covers one or more of the first connection structure and/or the second connection structure. The solid state circuit breaker of the above-noted EXAMPLE where the first connection structure is configured to change shape including straightening, rotating, and/or twisting; and where the second connection structure is configured to change shape including straightening, rotating, and/or twisting in a manner different from the first connection structure. The solid state circuit breaker of the above-noted EXAMPLE where a change in shape by the first connection structure is opposite to a change in shape of the second connection structure. The solid state circuit breaker of the above-noted EXAMPLE where the first connection structure comprises one or more metals, metal alloys, shape memory materials, shape memory alloys, memory metals, memory alloys, smart metals, and/or smart alloys; where the second connection structure comprises one or more metals, metal alloys, shape memory materials, shape memory alloys, memory metals, memory alloys, smart metals, and/or smart alloys; and where a material of the first connection structure is different from a material of the second connection structure. The solid state circuit breaker of the above-noted EXAMPLE where the first connection structure comprises an upper portion of material; and where the first connection structure comprises a lower portion of the first connection structure. The solid state circuit breaker of the above-noted EXAMPLE where a coefficient of thermal expansion (CTE) of a material of the upper portion of the first connection structure is different from a coefficient of thermal expansion (CTE) of a material of the lower portion of the first connection structure. The solid state circuit breaker of the above-noted EXAMPLE where a coefficient of thermal expansion (CTE) of the lower portion of the first connection structure is less than a coefficient of thermal expansion (CTE) of the upper portion of the first connection structure. The solid state circuit breaker of the above-noted EXAMPLE where the second connection structure comprises an upper portion of material; and where the second connection structure comprises a lower portion of the first connection structure. The solid state circuit breaker of the above-noted EXAMPLE where a coefficient of thermal expansion (CTE) of a material of a lower portion of the second connection structure is different from a coefficient of thermal expansion (CTE) of a material of an upper portion of the second connection structure. The solid state circuit breaker of the above-noted EXAMPLE where a coefficient of thermal expansion (CTE) of the lower portion of the second connection structure is greater than a coefficient of thermal expansion (CTE) of the upper portion of the second connection structure. The solid state circuit breaker of the above-noted EXAMPLE where the at least one fail-open device comprises at least one fuse; and where the at least one fail-open device is further configured with a first connection structure and a second connection structure. The solid state circuit breaker of the above-noted EXAMPLE includes: at least one second power device; and another implementation of the at least one fail-open device. The solid state circuit breaker of the above-noted EXAMPLE includes at least one second power device, where the at least one fail-open device is between the at least one power device and the power source; and/or where the at least one fail-open device is between the at least one second power device and the load. The solid state circuit breaker of the above-noted EXAMPLE where the solid state circuit breaker is implemented as a power package, a package, a power module, and/or a module. The solid state circuit breaker of the above-noted EXAMPLE where the at least one power device is implemented as a single standalone transistor, and/or a single cascode transistor. The solid state circuit breaker of the above-noted EXAMPLE where the solid state circuit breaker is implemented as a module containing multiple transistors, a module containing multiple standalone transistors, and/or a module containing multiple cascode transistors. The solid state circuit breaker of the above-noted EXAMPLE includes a plurality of paralleled implementations of the at least one power device and at least one second power device arranged along a lateral axis. The solid state circuit breaker of the above-noted EXAMPLE where the at least one power device comprises a single implementation of the at least one power device. The solid state circuit breaker of the above-noted EXAMPLE includes at least one second power device, where the at least one second power device comprises a single implementation of the at least one second power device; and where the at least one power device comprises a single implementation of the at least one power device. The solid state circuit breaker of the above-noted EXAMPLE where the control circuit comprises one or more of a gate driver, a control and sensing circuit, a current limiter, and/or a current sensor. The solid state circuit breaker of the above-noted EXAMPLE where the solid state circuit breaker is configured for a unidirectional implementation. The solid state circuit breaker of the above-noted EXAMPLE where the solid state circuit breaker is configured for a bidirectional implementation.

One EXAMPLE: a solid state circuit breaker includes at least one power device. The solid state circuit breaker in addition includes a control circuit configured to detect a fault and further configured to control operation of the at least one power device to open and electrically disconnect a power source from a load. The solid state circuit breaker moreover includes at least one fail-open device. The solid state circuit breaker also includes where the at least one fail-open device comprises at least one fuse and/or a first connection structure and a second connection structure.

The above-noted EXAMPLE may further include any one or a combination of more than one of the following EXAMPLES: The solid state circuit breaker of the above-noted EXAMPLE where the at least one fail-open device is configured to provide a physical disconnect in case of failure of the at least one power device and/or the control circuit. The solid state circuit breaker of the above-noted EXAMPLE where the at least one fail-open device is configured to provide a physical air-gap in case failure of the at least one power device and/or the control circuit. The solid state circuit breaker of the above-noted EXAMPLE where the at least one fuse configured to provide a physical air-gap in case of failure of the at least one power device and/or the control circuit. The solid state circuit breaker of the above-noted EXAMPLE where the first connection structure and the second connection structure are configured to provide a physical air-gap in case of failure of the at least one power device and/or the control circuit. The solid state circuit breaker of the above-noted EXAMPLE where the first connection structure is configured to be electrically connected to the second connection structure during at or below a rated current of the solid state circuit breaker. The solid state circuit breaker of the above-noted EXAMPLE where a connection between the first connection structure and the second connection structure is implemented by a mechanical interaction and/or mechanical arrangement between the first connection structure and the second connection structure. The solid state circuit breaker of the above-noted EXAMPLE where the first connection structure is configured to be electrically disconnected from the second connection structure during operations above a rated current of the solid state circuit breaker. The solid state circuit breaker of the above-noted EXAMPLE where the second connection structure is at least in part above the first connection structure. The solid state circuit breaker of the above-noted EXAMPLE where a coefficient of thermal expansion (CTE) of at least a part of a material of the first connection structure is different from a coefficient of thermal expansion (CTE) of at least a part of a material of the second connection structure. The solid state circuit breaker of the above-noted EXAMPLE where a coefficient of thermal expansion (CTE) of the first connection structure is less than a coefficient of thermal expansion (CTE) of the second connection structure. The solid state circuit breaker of the above-noted EXAMPLE where the first connection structure comprises an attachment portion, a body portion, and a connection portion; and where the second connection structure comprises an attachment portion, a body portion, and a connection portion. The solid state circuit breaker of the above-noted EXAMPLE where a coefficient of thermal expansion (CTE) of the body portion of the first connection structure and/or the connection portion of the first connection structure is different from a coefficient of thermal expansion (CTE) of the body portion of the second connection structure and/or the connection portion of the second connection structure. The solid state circuit breaker of the above-noted EXAMPLE where a coefficient of thermal expansion (CTE) of the body portion of the first connection structure and/or the connection portion of the first connection structure is less than a coefficient of thermal expansion (CTE) of the body portion of the second connection structure and/or the connection portion of the second connection structure. The solid state circuit breaker of the above-noted EXAMPLE where the connection portion of the second connection structure is configured to be electrically connected to the connection portion of the first connection structure. The solid state circuit breaker of the above-noted EXAMPLE where the connection portion of the second connection structure is configured to be electrically disconnected from the connection portion of the first connection structure during operations above a rated current of the solid state circuit breaker. The solid state circuit breaker of the above-noted EXAMPLE where the connection portion of the second connection structure is above the connection portion of the first connection structure. The solid state circuit breaker of the above-noted EXAMPLE includes an encapsulation configured to provide cooling, where the encapsulation is configured to allow for movement of the at least one fail-open device. The solid state circuit breaker of the above-noted EXAMPLE where the encapsulation partially encloses and/or covers one or more of the first connection structure and/or the second connection structure. The solid state circuit breaker of the above-noted EXAMPLE where the first connection structure is configured to change shape including straightening, rotating, and/or twisting; and where the second connection structure is configured to change shape including straightening, rotating, and/or twisting in a manner different from the first connection structure. The solid state circuit breaker of the above-noted EXAMPLE where a change in shape by the first connection structure is opposite to a change in shape of the second connection structure. The solid state circuit breaker of the above-noted EXAMPLE where the first connection structure comprises one or more metals, metal alloys, shape memory materials, shape memory alloys, memory metals, memory alloys, smart metals, and/or smart alloys; where the second connection structure comprises one or more metals, metal alloys, shape memory materials, shape memory alloys, memory metals, memory alloys, smart metals, and/or smart alloys; and where a material of the first connection structure is different from a material of the second connection structure. The solid state circuit breaker of the above-noted EXAMPLE where the first connection structure comprises an upper portion of material; and where the first connection structure comprises a lower portion of the first connection structure. The solid state circuit breaker of the above-noted EXAMPLE where a coefficient of thermal expansion (CTE) of a material of the upper portion of the first connection structure is different from a coefficient of thermal expansion (CTE) of a material of the lower portion of the first connection structure. The solid state circuit breaker of the above-noted EXAMPLE where a coefficient of thermal expansion (CTE) of the lower portion of the first connection structure is less than a coefficient of thermal expansion (CTE) of the upper portion of the first connection structure. The solid state circuit breaker of the above-noted EXAMPLE where the second connection structure comprises an upper portion of material; and where the second connection structure comprises a lower portion of the first connection structure. The solid state circuit breaker of the above-noted EXAMPLE where a coefficient of thermal expansion (CTE) of a material of a lower portion of the second connection structure is different from a coefficient of thermal expansion (CTE) of a material of an upper portion of the second connection structure. The solid state circuit breaker of the above-noted EXAMPLE where a coefficient of thermal expansion (CTE) of the lower portion of the second connection structure is greater than a coefficient of thermal expansion (CTE) of the upper portion of the second connection structure. The solid state circuit breaker of the above-noted EXAMPLE where the at least one fail-open device comprises at least one fuse; and where the at least one fail-open device is further configured with a first connection structure and a second connection structure. The solid state circuit breaker of the above-noted EXAMPLE where the at least one fail-open device comprises a plurality of paralleled implementations of the at least one fuse. The solid state circuit breaker of the above-noted EXAMPLE includes an encapsulation configured to provide cooling, where the encapsulation is configured to allow access to the at least one fuse. The solid state circuit breaker of the above-noted EXAMPLE includes: at least one second power device; and another implementation of the at least one fuse. The solid state circuit breaker of the above-noted EXAMPLE includes: at least one second power device; and another implementation of the at least one fail-open device. The solid state circuit breaker of the above-noted EXAMPLE includes at least one second power device, where the at least one fail-open device is between the at least one power device and the power source; and/or where the at least one fail-open device is between the at least one second power device and the load. The solid state circuit breaker of the above-noted EXAMPLE where the solid state circuit breaker is implemented as a power package, a package, a power module, and/or a module. The solid state circuit breaker of the above-noted EXAMPLE where the at least one power device is implemented as a single standalone transistor, and/or a single cascode transistor. The solid state circuit breaker of the above-noted EXAMPLE where the solid state circuit breaker is implemented as a module containing multiple transistors, a module containing multiple standalone transistors, and/or a module containing multiple cascodes transistors. The solid state circuit breaker of the above-noted EXAMPLE includes a plurality of paralleled implementations of the at least one power device and at least one second power device arranged along a lateral axis. The solid state circuit breaker of the above-noted EXAMPLE where the at least one power device comprises a single implementation of the at least one power device. The solid state circuit breaker of the above-noted EXAMPLE includes at least one second power device, where the at least one second power device comprises a single implementation of the at least one second power device; and where the at least one power device comprises a single implementation of the at least one power device. The solid state circuit breaker of the above-noted EXAMPLE where the control circuit comprises one or more of a gate driver, a control and sensing circuit, a current limiter, and/or a current sensor. The solid state circuit breaker of the above-noted EXAMPLE where the solid state circuit breaker is configured for a unidirectional implementation. The solid state circuit breaker of the above-noted EXAMPLE where the solid state circuit breaker is configured for a bidirectional implementation.

One EXAMPLE: a process includes providing at least one power device. The process in addition includes detecting a fault with a control circuit and controlling with the control circuit an operation of the at least one power device to open and electrically disconnect a power source from a load. The process moreover includes providing at least one fail-open device.

The above-noted EXAMPLE may further include any one or a combination of more than one of the following EXAMPLES: The process of the above-noted EXAMPLE where the at least one fail-open device is configured to provide a physical disconnect in case of failure of the at least one power device and/or the control circuit. The process of the above-noted EXAMPLE where the at least one fail-open device is configured to provide a physical air-gap in case failure of the at least one power device and/or the control circuit. The process of the above-noted EXAMPLE where the at least one fail-open device comprises at least one fuse. The process of the above-noted EXAMPLE where the at least one fail-open device comprises a plurality of paralleled implementations of the at least one fuse. The process of the above-noted EXAMPLE includes configuring an encapsulation to provide cooling, where the encapsulation is configured to allow access to the at least one fuse. The process of the above-noted EXAMPLE includes: providing at least one second power device; and providing another implementation of the at least one fuse. The process of the above-noted EXAMPLE where the at least one fail-open device comprises at least one fuse configured to provide a physical air-gap in case of failure of the at least one power device and/or the control circuit. The process of the above-noted EXAMPLE where the at least one fail-open device comprises a first connection structure and a second connection structure. The process of the above-noted EXAMPLE where the at least one fail-open device comprises a first connection structure and a second connection structure configured to provide a physical air-gap in case of failure of the at least one power device and/or the control circuit. The process of the above-noted EXAMPLE where the first connection structure is configured to be electrically connected to the second connection structure during at or below a rated current of the solid state circuit breaker. The process of the above-noted EXAMPLE where a connection between the first connection structure and the second connection structure is implemented by a mechanical interaction and/or mechanical arrangement between the first connection structure and the second connection structure. The process of the above-noted EXAMPLE where the first connection structure is configured to be electrically disconnected from the second connection structure during operations above a rated current of the solid state circuit breaker. The process of the above-noted EXAMPLE where the second connection structure is at least in part above the first connection structure. The process of the above-noted EXAMPLE where a coefficient of thermal expansion (CTE) of at least a part of a material of the first connection structure is different from a coefficient of thermal expansion (CTE) of at least a part of a material of the second connection structure. The process of the above-noted EXAMPLE where a coefficient of thermal expansion (CTE) of the first connection structure is less than a coefficient of thermal expansion (CTE) of the second connection structure. The process of the above-noted EXAMPLE where the first connection structure comprises an attachment portion, a body portion, and a connection portion; and where the second connection structure comprises an attachment portion, a body portion, and a connection portion. The process of the above-noted EXAMPLE where a coefficient of thermal expansion (CTE) of the body portion of the first connection structure and/or the connection portion of the first connection structure is different from a coefficient of thermal expansion (CTE) of the body portion of the second connection structure and/or the connection portion of the second connection structure. The process of the above-noted EXAMPLE where a coefficient of thermal expansion (CTE) of the body portion of the first connection structure and/or the connection portion of the first connection structure is less than a coefficient of thermal expansion (CTE) of the body portion of the second connection structure and/or the connection portion of the second connection structure. The process of the above-noted EXAMPLE where the connection portion of the second connection structure is configured to be electrically connected to the connection portion of the first connection structure. The process of the above-noted EXAMPLE where the connection portion of the second connection structure is configured to be electrically disconnected from the connection portion of the first connection structure during operations above a rated current of the solid state circuit breaker. The process of the above-noted EXAMPLE where the connection portion of the second connection structure is above the connection portion of the first connection structure. The process of the above-noted EXAMPLE includes configuring an encapsulation to provide cooling, where the encapsulation is configured to allow for movement of the at least one fail-open device. The process of the above-noted EXAMPLE where the encapsulation partially encloses and/or covers one or more of the first connection structure and/or the second connection structure. The process of the above-noted EXAMPLE where the first connection structure is configured to change shape including straightening, rotating, and/or twisting; and where the second connection structure is configured to change shape including straightening, rotating, and/or twisting in a manner different from the first connection structure. The process of the above-noted EXAMPLE where a change in shape by the first connection structure is opposite to a change in shape of the second connection structure. The process of the above-noted EXAMPLE where the first connection structure comprises one or more metals, metal alloys, shape memory materials, shape memory alloys, memory metals, memory alloys, smart metals, and/or smart alloys; where the second connection structure comprises one or more metals, metal alloys, shape memory materials, shape memory alloys, memory metals, memory alloys, smart metals, and/or smart alloys; and where a material of the first connection structure is different from a material of the second connection structure. The process of the above-noted EXAMPLE where the first connection structure comprises an upper portion of material; and where the first connection structure comprises a lower portion of the first connection structure. The process of the above-noted EXAMPLE where a coefficient of thermal expansion (CTE) of a material of the upper portion of the first connection structure is different from a coefficient of thermal expansion (CTE) of a material of the lower portion of the first connection structure. The process of the above-noted EXAMPLE where a coefficient of thermal expansion (CTE) of the lower portion of the first connection structure is less than a coefficient of thermal expansion (CTE) of the upper portion of the first connection structure. The process of the above-noted EXAMPLE where the second connection structure comprises an upper portion of material; and where the second connection structure comprises a lower portion of the first connection structure. The process of the above-noted EXAMPLE where a coefficient of thermal expansion (CTE) of a material of a lower portion of the second connection structure is different from a coefficient of thermal expansion (CTE) of a material of an upper portion of the second connection structure. The process of the above-noted EXAMPLE where a coefficient of thermal expansion (CTE) of the lower portion of the second connection structure is greater than a coefficient of thermal expansion (CTE) of the upper portion of the second connection structure. The process of the above-noted EXAMPLE where the at least one fail-open device comprises at least one fuse; and where the at least one fail-open device is further configured with a first connection structure and a second connection structure. The process of the above-noted EXAMPLE includes: providing at least one second power device; and providing another implementation of the at least one fail-open device. The process of the above-noted EXAMPLE includes providing at least one second power device, where the at least one fail-open device is between the at least one power device and the power source; and/or where the at least one fail-open device is between the at least one second power device and the load. The process of the above-noted EXAMPLE where the solid state circuit breaker is implemented as a power package, a package, a power module, and/or a module. The process of the above-noted EXAMPLE where the at least one power device is implemented as a single standalone transistor and/or a single cascode transistor. The process of the above-noted EXAMPLE where the solid state circuit breaker is implemented as a module containing multiple transistors, a module containing multiple standalone transistors, and/or a module containing multiple cascodes transistors. The process of the above-noted EXAMPLE includes arranging a plurality of paralleled implementations of the at least one power device and at least one second power device along a lateral axis. The process of the above-noted EXAMPLE where the at least one power device comprises a single implementation of the at least one power device. The process of the above-noted EXAMPLE includes providing at least one second power device, where the at least one second power device comprises a single implementation of the at least one second power device; and where the at least one power device comprises a single implementation of the at least one power device. The process of the above-noted EXAMPLE where the control circuit comprises one or more of a gate driver, a control and sensing circuit, a current limiter, and/or a current sensor. The process of the above-noted EXAMPLE where the solid state circuit breaker is configured for a unidirectional implementation. The process of the above-noted EXAMPLE where the solid state circuit breaker is configured for a bidirectional implementation.

One EXAMPLE: a process includes providing at least one power device. The process in addition includes detecting a fault with a control circuit and controlling with the control circuit an operation of the at least one power device to open and electrically disconnect a power source from a load. The process moreover includes providing at least one fail-open device. The process also includes where the at least one fail-open device comprises at least one fuse and/or a first connection structure and a second connection structure.

The above-noted EXAMPLE may further include any one or a combination of more than one of the following EXAMPLES: The process of the above-noted EXAMPLE where the at least one fail-open device is configured to provide a physical disconnect in case of failure of the at least one power device and/or the control circuit. The process of the above-noted EXAMPLE where the at least one fail-open device is configured to provide a physical air-gap in case failure of the at least one power device and/or the control circuit. The process of the above-noted EXAMPLE where the at least one fuse configured to provide a physical air-gap in case of failure of the at least one power device and/or the control circuit. The process of the above-noted EXAMPLE where the first connection structure and the second connection structure are configured to provide a physical air-gap in case of failure of the at least one power device and/or the control circuit. The process of the above-noted EXAMPLE where the first connection structure is configured to be electrically connected to the second connection structure during at or below a rated current of the solid state circuit breaker. The process of the above-noted EXAMPLE where a connection between the first connection structure and the second connection structure is implemented by a mechanical interaction and/or mechanical arrangement between the first connection structure and the second connection structure. The process of the above-noted EXAMPLE where the first connection structure is configured to be electrically disconnected from the second connection structure during operations above a rated current of the solid state circuit breaker. The process of the above-noted EXAMPLE where the second connection structure is at least in part above the first connection structure. The process of the above-noted EXAMPLE where a coefficient of thermal expansion (CTE) of at least a part of a material of the first connection structure is different from a coefficient of thermal expansion (CTE) of at least a part of a material of the second connection structure. The process of the above-noted EXAMPLE where a coefficient of thermal expansion (CTE) of the first connection structure is less than a coefficient of thermal expansion (CTE) of the second connection structure. The process of the above-noted EXAMPLE where the first connection structure comprises an attachment portion, a body portion, and a connection portion; and where the second connection structure comprises an attachment portion, a body portion, and a connection portion. The process of the above-noted EXAMPLE where a coefficient of thermal expansion (CTE) of the body portion of the first connection structure and/or the connection portion of the first connection structure is different from a coefficient of thermal expansion (CTE) of the body portion of the second connection structure and/or the connection portion of the second connection structure. The process of the above-noted EXAMPLE where a coefficient of thermal expansion (CTE) of the body portion of the first connection structure and/or the connection portion of the first connection structure is less than a coefficient of thermal expansion (CTE) of the body portion of the second connection structure and/or the connection portion of the second connection structure. The process of the above-noted EXAMPLE where the connection portion of the second connection structure is configured to be electrically connected to the connection portion of the first connection structure. The process of the above-noted EXAMPLE where the connection portion of the second connection structure is configured to be electrically disconnected from the connection portion of the first connection structure during operations above a rated current of the solid state circuit breaker. The process of the above-noted EXAMPLE where the connection portion of the second connection structure is above the connection portion of the first connection structure. The process of the above-noted EXAMPLE includes configuring an encapsulation to provide cooling, where the encapsulation is configured to allow for movement of the at least one fail-open device. The process of the above-noted EXAMPLE where the encapsulation partially encloses and/or covers one or more of the first connection structure and/or the second connection structure. The process of the above-noted EXAMPLE where the first connection structure is configured to change shape including straightening, rotating, and/or twisting; and where the second connection structure is configured to change shape including straightening, rotating, and/or twisting in a manner different from the first connection structure. The process of the above-noted EXAMPLE where a change in shape by the first connection structure is opposite to a change in shape of the second connection structure. The process of the above-noted EXAMPLE where the first connection structure comprises one or more metals, metal alloys, shape memory materials, shape memory alloys, memory metals, memory alloys, smart metals, and/or smart alloys; where the second connection structure comprises one or more metals, metal alloys, shape memory materials, shape memory alloys, memory metals, memory alloys, smart metals, and/or smart alloys; and where a material of the first connection structure is different from a material of the second connection structure. The process of the above-noted EXAMPLE where the first connection structure comprises an upper portion of material; and where the first connection structure comprises a lower portion of the first connection structure. The process of the above-noted EXAMPLE where a coefficient of thermal expansion (CTE) of a material of the upper portion of the first connection structure is different from a coefficient of thermal expansion (CTE) of a material of the lower portion of the first connection structure. The process of the above- noted EXAMPLE where a coefficient of thermal expansion (CTE) of the lower portion of the first connection structure is less than a coefficient of thermal expansion (CTE) of the upper portion of the first connection structure. The process of the above-noted EXAMPLE where the second connection structure comprises an upper portion of material; and where the second connection structure comprises a lower portion of the first connection structure. The process of the above-noted EXAMPLE where a coefficient of thermal expansion (CTE) of a material of a lower portion of the second connection structure is different from a coefficient of thermal expansion (CTE) of a material of an upper portion of the second connection structure. The process of the above-noted EXAMPLE where a coefficient of thermal expansion (CTE) of the lower portion of the second connection structure is greater than a coefficient of thermal expansion (CTE) of the upper portion of the second connection structure. The process of the above-noted EXAMPLE where the at least one fail-open device comprises at least one fuse; and where the at least one fail-open device is further configured with a first connection structure and a second connection structure. The process of the above-noted EXAMPLE where the at least one fail-open device comprises a plurality of paralleled implementations of the at least one fuse. The process of the above-noted EXAMPLE includes configuring an encapsulation to provide cooling, where the encapsulation is configured to allow access to the at least one fuse. The process of the above-noted EXAMPLE includes: providing at least one second power device; and providing another implementation of the at least one fuse. The process of the above-noted EXAMPLE includes: providing at least one second power device; and providing another implementation of the at least one fail-open device. The process of the above-noted EXAMPLE includes providing at least one second power device, where the at least one fail-open device is between the at least one power device and the power source; and/or where the at least one fail-open device is between the at least one second power device and the load. The process of the above-noted EXAMPLE where the solid state circuit breaker is implemented as a power package, a package, a power module, and/or a module. The process of the above-noted EXAMPLE where the at least one power device is implemented as a single standalone transistor and/or a single cascode transistor. The process of the above-noted EXAMPLE where the solid state circuit breaker is implemented as a module containing multiple transistors, a module containing multiple standalone transistors, and/or a module containing multiple cascodes transistors. The process of the above-noted EXAMPLE includes arranging a plurality of paralleled implementations of the at least one power device and at least one second power device along a lateral axis. The process of the above-noted EXAMPLE where the at least one power device comprises a single implementation of the at least one power device. The process of the above-noted EXAMPLE includes providing at least one second power device, where the at least one second power device comprises a single implementation of the at least one second power device; and where the at least one power device comprises a single implementation of the at least one power device. The process of the above-noted EXAMPLE where the control circuit comprises one or more of a gate driver, a control and sensing circuit, a current limiter, and/or a current sensor. The process of the above-noted EXAMPLE where the solid state circuit breaker is configured for a unidirectional implementation. The process of the above-noted EXAMPLE where the solid state circuit breaker is configured for a bidirectional implementation.

One EXAMPLE: a fail-open device includes a first connection structure. The fail-open device in addition includes a second connection structure. The fail-open device moreover includes where the first connection structure is configured to be electrically disconnected from the second connection structure above a certain current flow.

The above-noted EXAMPLE may further include any one or a combination of more than one of the following EXAMPLES: The fail-open device of the above-noted EXAMPLE where the first connection structure and the second connection structure are configured to provide a physical disconnect. The fail-open device of the above-noted EXAMPLE where the first connection structure and the second connection structure are configured to provide a physical air-gap. The fail-open device of the above-noted EXAMPLE includes at least one fuse. The fail-open device of the above-noted EXAMPLE includes a plurality of paralleled implementations of the at least one fuse. p The fail-open device of the above-noted EXAMPLE includes an encapsulation configured to provide cooling, where the encapsulation is configured to allow access to the at least one fuse. The fail-open device of the above-noted EXAMPLE where the first connection structure is configured to be electrically connected to the second connection structure during at or below a rated current. The fail-open device of the above-noted EXAMPLE where a connection between the first connection structure and the second connection structure is implemented by a mechanical interaction and/or mechanical arrangement between the first connection structure and the second connection structure. The fail-open device of the above-noted EXAMPLE where the first connection structure is configured to be electrically disconnected from the second connection structure during operations above a rated current. The fail-open device of the above-noted EXAMPLE where the second connection structure is at least in part above the first connection structure. The fail-open device of the above-noted EXAMPLE where a coefficient of thermal expansion (CTE) of at least a part of a material of the first connection structure is different from a coefficient of thermal expansion (CTE) of at least a part of a material of the second connection structure. The fail-open device of the above-noted EXAMPLE where a coefficient of thermal expansion (CTE) of the first connection structure is less than a coefficient of thermal expansion (CTE) of the second connection structure. The fail-open device of the above-noted EXAMPLE where the first connection structure comprises an attachment portion, a body portion, and a connection portion; and where the second connection structure comprises an attachment portion, a body portion, and a connection portion. The fail-open device of the above-noted EXAMPLE where a coefficient of thermal expansion (CTE) of the body portion of the first connection structure and/or the connection portion of the first connection structure is different from a coefficient of thermal expansion (CTE) of the body portion of the second connection structure and/or the connection portion of the second connection structure. The fail-open device of the above-noted EXAMPLE where a coefficient of thermal expansion (CTE) of the body portion of the first connection structure and/or the connection portion of the first connection structure is less than a coefficient of thermal expansion (CTE) of the body portion of the second connection structure and/or the connection portion of the second connection structure. The fail-open device of the above-noted EXAMPLE where the connection portion of the second connection structure is configured to be electrically connected to the connection portion of the first connection structure. The fail-open device of the above-noted EXAMPLE where the connection portion of the second connection structure is configured to be electrically disconnected from the connection portion of the first connection structure during operations above a rated current. The fail - open device of the above-noted EXAMPLE where the connection portion of the second connection structure is above the connection portion of the first connection structure. The fail-open device of the above-noted EXAMPLE where the first connection structure is configured to change shape including straightening, rotating, and/or twisting; and where the second connection structure is configured to change shape including straightening, rotating, and/or twisting in a manner different from the first connection structure. The fail-open device of the above-noted EXAMPLE where a change in shape by the first connection structure is opposite to a change in shape of the second connection structure. The fail-open device of the above-noted EXAMPLE where the first connection structure comprises one or more metals, metal alloys, shape memory materials, shape memory alloys, memory metals, memory alloys, smart metals, and/or smart alloys; where the second connection structure comprises one or more metals, metal alloys, shape memory materials, shape memory alloys, memory metals, memory alloys, smart metals, and/or smart alloys; and where a material of the first connection structure is different from a material of the second connection structure. The fail-open device of the above-noted EXAMPLE where the first connection structure comprises an upper portion of material; and where the first connection structure comprises a lower portion of the first connection structure. The fail-open device of the above-noted EXAMPLE where a coefficient of thermal expansion (CTE) of a material of the upper portion of the first connection structure is different from a coefficient of thermal expansion (CTE) of a material of the lower portion of the first connection structure. The fail-open device of the above-noted EXAMPLE where a coefficient of thermal expansion (CTE) of the lower portion of the first connection structure is less than a coefficient of thermal expansion (CTE) of the upper portion of the first connection structure. The fail-open device of the above-noted EXAMPLE where the second connection structure comprises an upper portion of material; and where the second connection structure comprises a lower portion of the first connection structure. The fail-open device of the above-noted EXAMPLE where a coefficient of thermal expansion (CTE) of a material of a lower portion of the second connection structure is different from a coefficient of thermal expansion (CTE) of a material of an upper portion of the second connection structure. The fail-open device of the above-noted EXAMPLE where a coefficient of thermal expansion (CTE) of the lower portion of the second connection structure is greater than a coefficient of thermal expansion (CTE) of the upper portion of the second connection structure.

One EXAMPLE: a process includes providing a first connection structure. The process in addition includes providing a second connection structure. The process moreover includes configuring at least the first connection structure to be electrically disconnected from the second connection structure above a certain current flow.

The above-noted EXAMPLE may further include any one or a combination of more than one of the following EXAMPLES: The process of the above-noted EXAMPLE where the first connection structure and the second connection structure are configured to provide a physical disconnect. The process of the above-noted EXAMPLE where the first connection structure and the second connection structure are configured to provide a physical air-gap. The process of the above-noted EXAMPLE includes providing at least one fuse. The process of the above-noted EXAMPLE where the at least one fuse is configured to provide a physical air-gap. The process of the above-noted EXAMPLE where the at least one fuse comprises a plurality of paralleled implementations of the at least one fuse. The process of the above-noted EXAMPLE includes configuring an encapsulation to provide cooling, where the encapsulation is configured to allow access to the at least one fuse. The process of the above-noted EXAMPLE where the first connection structure is configured to be electrically connected to the second connection structure during at or below a rated current. The process of the above-noted EXAMPLE where a connection between the first connection structure and the second connection structure is implemented by a mechanical interaction and/or mechanical arrangement between the first connection structure and the second connection structure. The process of the above-noted EXAMPLE where the first connection structure is configured to be electrically disconnected from the second connection structure during operations above a rated current. The process of the above-noted EXAMPLE where the second connection structure is at least in part above the first connection structure. The process of the above-noted EXAMPLE where a coefficient of thermal expansion (CTE) of at least a part of a material of the first connection structure is different from a coefficient of thermal expansion (CTE) of at least a part of a material of the second connection structure. The process of the above-noted EXAMPLE where a coefficient of thermal expansion (CTE) of the first connection structure is less than a coefficient of thermal expansion (CTE) of the second connection structure. The process of the above-noted EXAMPLE where the first connection structure comprises an attachment portion, a body portion, and a connection portion; and where the second connection structure comprises an attachment portion, a body portion, and a connection portion. The process of the above-noted EXAMPLE where a coefficient of thermal expansion (CTE) of the body portion of the first connection structure and/or the connection portion of the first connection structure is different from a coefficient of thermal expansion (CTE) of the body portion of the second connection structure and/or the connection portion of the second connection structure. The process of the above-noted EXAMPLE where a coefficient of thermal expansion (CTE) of the body portion of the first connection structure and/or the connection portion of the first connection structure is less than a coefficient of thermal expansion (CTE) of the body portion of the second connection structure and/or the connection portion of the second connection structure. The process of the above-noted EXAMPLE where the connection portion of the second connection structure is configured to be electrically connected to the connection portion of the first connection structure. The process of the above-noted EXAMPLE where the connection portion of the second connection structure is configured to be electrically disconnected from the connection portion of the first connection structure during operations above a rated current. The process of the above- noted EXAMPLE where the connection portion of the second connection structure is above the connection portion of the first connection structure. The process of the above-noted EXAMPLE includes configuring an encapsulation to provide cooling, where the encapsulation is configured to allow for movement of the first connection structure and/or the second connection structure. The process of the above-noted EXAMPLE where the encapsulation partially encloses and/or covers one or more of the first connection structure and/or the second connection structure. The process of the above-noted EXAMPLE where the first connection structure is configured to change shape including straightening, rotating, and/or twisting; and where the second connection structure is configured to change shape including straightening, rotating, and/or twisting in a manner different from the first connection structure. The process of the above-noted EXAMPLE where a change in shape by the first connection structure is opposite to a change in shape of the second connection structure. The process of the above-noted EXAMPLE where the first connection structure comprises one or more metals, metal alloys, shape memory materials, shape memory alloys, memory metals, memory alloys, smart metals, and/or smart alloys; where the second connection structure comprises one or more metals, metal alloys, shape memory materials, shape memory alloys, memory metals, memory alloys, smart metals, and/or smart alloys; and where a material of the first connection structure is different from a material of the second connection structure. The process of the above-noted EXAMPLE where the first connection structure comprises an upper portion of material; and where the first connection structure comprises a lower portion of the first connection structure. The process of the above-noted EXAMPLE where a coefficient of thermal expansion (CTE) of a material of the upper portion of the first connection structure is different from a coefficient of thermal expansion (CTE) of a material of the lower portion of the first connection structure. The process of the above-noted EXAMPLE where a coefficient of thermal expansion (CTE) of the lower portion of the first connection structure is less than a coefficient of thermal expansion (CTE) of the upper portion of the first connection structure. The process of the above-noted EXAMPLE where the second connection structure comprises an upper portion of material; and where the second connection structure comprises a lower portion of the first connection structure. The process of the above-noted EXAMPLE where a coefficient of thermal expansion (CTE) of a material of a lower portion of the second connection structure is different from a coefficient of thermal expansion (CTE) of a material of an upper portion of the second connection structure. The process of the above-noted EXAMPLE where a coefficient of thermal expansion (CTE) of the lower portion of the second connection structure is greater than a coefficient of thermal expansion (CTE) of the upper portion of the second connection structure.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto another element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over another element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

1. A solid state circuit breaker comprising:
at least one power device;
a control circuit configured to detect a fault and further configured to control operation of the at least one power device to open and electrically disconnect a power source from a load; and
at least one fail-open device.

2. The solid state circuit breaker according to claim 1, wherein the at least one fail-open device is configured to provide a physical disconnect in case of failure of the at least one power device and/or the control circuit.

3. (canceled)

4. The solid state circuit breaker according to claim 1, wherein the at least one fail-open device comprises at least one fuse.

5. (canceled)

6. The solid state circuit breaker according to claim 1, wherein the at least one fail-open device comprises a first connection structure and a second connection structure.

7. The solid state circuit breaker according to claim 6, wherein the at least one fail-open device comprises a first connection structure and a second connection structure are configured to provide a physical air-gap in case of failure of the at least one power device and/or the control circuit.

8.-11. (canceled)

12. The solid state circuit breaker according to claim 6, wherein a coefficient of thermal expansion (CTE) of at least a part of a material of the first connection structure is different from a coefficient of thermal expansion (CTE) of at least a part of a material of the second connection structure.

13. (canceled)

14. The solid state circuit breaker according to claim 6,
wherein the first connection structure comprises an attachment portion, a body portion, and a connection portion; and
wherein the second connection structure comprises an attachment portion, a body portion, and a connection portion.

15. The solid state circuit breaker according to claim 14, wherein a coefficient of thermal expansion (CTE) of the body portion of the first connection structure and/or the connection portion of the first connection structure is different from a coefficient of thermal expansion (CTE) of the body portion of the second connection structure and/or the connection portion of the second connection structure.

16.-19. (canceled)

20. The solid state circuit breaker according to claim 6, further comprising an encapsulation configured to provide cooling,
wherein the encapsulation is configured to allow for movement of the at least one fail-open device.

21. (canceled)

22. The solid state circuit breaker according to claim 6,
wherein the first connection structure is configured to change shape including straightening, rotating, and/or twisting; and
wherein the second connection structure is configured to change shape including straightening, rotating, and/or twisting in a manner different from the first connection structure.

23. The solid state circuit breaker according to claim 22, wherein a change in shape by the first connection structure is opposite to a change in shape of the second connection structure.

24. The solid state circuit breaker according to claim 6,
wherein the first connection structure comprises one or more metals, metal alloys, shape memory materials, shape memory alloys, memory metals, memory alloys, smart metals, and/or smart alloys;
wherein the second connection structure comprises one or more metals, metal alloys, shape memory materials, shape memory alloys, memory metals, memory alloys, smart metals, and/or smart alloys; and
wherein a material of the first connection structure is different from a material of the second connection structure.

25. The solid state circuit breaker according to claim 6,
wherein the first connection structure comprises an upper portion of material; and
wherein the first connection structure comprises a lower portion of the first connection structure.

26. The solid state circuit breaker according to claim 25, wherein a coefficient of thermal expansion (CTE) of a material of the upper portion of the first connection structure is different from a coefficient of thermal expansion (CTE) of a material of the lower portion of the first connection structure.

27. (canceled)

28. The solid state circuit breaker according to claim 6,
wherein the second connection structure comprises an upper portion of material; and
wherein the second connection structure comprises a lower portion of the first connection structure.

29. The solid state circuit breaker according to claim 28, wherein a coefficient of thermal expansion (CTE) of a material of a lower portion of the second connection structure is different from a coefficient of thermal expansion (CTE) of a material of an upper portion of the second connection structure.

30. (canceled)

31. The solid state circuit breaker according to claim 1,
wherein the at least one fail-open device comprises at least one fuse; and
wherein the at least one fail-open device is further configured with a first connection structure and a second connection structure.

32. The solid state circuit breaker according to claim 4, wherein the at least one fail-open device comprises a plurality of paralleled implementations of the at least one fuse.

33. (canceled)

34. The solid state circuit breaker according to claim 4, further comprising:
at least one second power device; and
another implementation of the at least one fuse.

35. The solid state circuit breaker according to claim 1, further comprising:
at least one second power device; and
another implementation of the at least one fail-open device.

36. The solid state circuit breaker according to claim 1, further comprising at least one second power device,
wherein the at least one fail-open device is between the at least one power device and the power source; and/or wherein the at least one fail-open device is between the at least one second power device and the load.

37. The solid state circuit breaker according to claim 1, wherein the solid state circuit breaker is implemented as a power package, a package, a power module, and/or a module.

38. The solid state circuit breaker according to claim 1, wherein the at least one power device is implemented as a single standalone transistor and/or a single cascode transistor.

39.-45. (canceled)

46. A solid state circuit breaker comprising:
at least one power device;
a control circuit configured to detect a fault and further configured to control operation of the at least one power device to open and electrically disconnect a power source from a load; and
at least one fail-open device,
wherein the at least one fail-open device comprises at least one fuse and/or a first connection structure and a second connection structure.

47.-49. (canceled)

50. The solid state circuit breaker according to claim 46, wherein the first connection structure and the second connection structure are configured to provide a physical air-gap in case of failure of the at least one power device and/or the control circuit.

51.-176. (canceled)

177. A fail-open device comprising:
a first connection structure; and
a second connection structure,
wherein the first connection structure is configured to be electrically disconnected from the second connection structure above a certain current flow.

178. The fail-open device according to claim 177, wherein the first connection structure and the second connection structure are configured to provide a physical disconnect.

179.-233. (canceled)

234. The fail-open device according to claim 6, wherein the first connection structure and the second connection structure are configured to be electrically disconnected and stay disconnected.

235. The fail-open device according to claim 6, wherein the first connection structure and the second connection structure are configured to be electrically disconnected and subsequently reconnect.

236. The fail-open device according to claim 1, further comprising a monitoring circuit configured to measure a number of operations and/or a frequency of operations of the at least one fail-open device.

237. The fail-open device according to claim 46, wherein the first connection structure and the second connection structure are configured to be electrically disconnected and stay disconnected.

238. The fail-open device according to claim 46, wherein the first connection structure and the second connection structure are configured to be electrically disconnected and subsequently reconnect.

239. The fail-open device according to claim 46, further comprising a monitoring circuit configured to measure a number of operations and/or a frequency of operations of the at least one fail-open device.

240. The fail-open device according to claim 177, wherein the first connection structure and the second connection structure are configured to be electrically disconnected and stay disconnected.

241. The fail-open device according to claim 177, wherein the first connection structure and the second connection structure are configured to be electrically disconnected and subsequently reconnect.

242. The fail-open device according to claim 177, further comprising a monitoring circuit configured to measure a number of operations and/or a frequency of operations of the at least one fail-open device.
